(19) United States
(12) Patent Application Publication
(10) Pub. No.: US 2011/0206816 A1
(43) Pub. Date: Aug. 25, 2011

(54) Method For Reducing Afla-And Ochratoxin Contamination In Cereals, Nuts, Fruits And Spices

(75) Inventors: Ruth Meissner, Leverkusen (DE); Isolde Häuser-Hahn, Leverkusen (DE); Karin Guendel-Gonzalez, Dormagen (DE)

(73) Assignee: BAYER CROPSCIENCE AG, MONHEIM (DE)

(21) Appl. No.: 12/745,455

(22) PCT Filed: Nov. 20, 2008
(86) PCT No.: PCT/EP08/09789

§ 371 Date: Dec. 2, 2010

(30) Foreign Application Priority Data
Nov. 29, 2007 (EP) 07121936.4

(51) Int. Cl. A23L 3/3463

(52) U.S. Cl. 426/331; 426/335

(57) ABSTRACT

The present application relates to a method for the reduction of afla- and ochratoxin contamination of cereal, nut, fruit and spice plants and/or plant material from cereals, nuts, fruits and spices before or after harvest or during storage and during storage, in particular genetically modified cereals, nuts, fruits and spices by the use of one or a combination of two or more fungicidally active compounds.

The present application relates to a method for the reduction of afla- and ochratoxin contamination of cereals, nuts, fruits and spices and/or plant material from cereals, nuts, fruits and spices before or after harvest or during storage, in particular genetically modified cereals, nuts, fruits and spices by the use of one or a combination of two or more fungicidally active compounds.

Numerous fungi are serious pests of economically important agricultural crops. Further, crop contamination by fungal toxins is a major problem for agriculture throughout the world.

Afla- and ochratoxins are toxic fungal metabolites, often found in agricultural products that are characterized by their ability to cause health problems for humans and vertebrates. They are produced for example by different Aspergillus and Penicilium species.

Aflatoxins are toxins produced by Aspergillus species that grow on several crops, in particular on cereals, nuts, fruits and spices before or after harvest or during storage of the crops. The biosynthesis of aflatoxins involves a complex polyketide pathway starting with acetate and malonate. One important intermediate is sterigmatocystin and O-methylsterigmatocystin which are direct precursors of aflatoxins. Important producers of aflatoxins are Aspergillus flavus, most strains of Aspergillus parasiticus, Aspergillus nomius, Aspergillus bombycis, Aspergillus pseudotamarii, Aspergillus ochraceoroseus, Aspergillus rambelli, Emericella astellata, Emericella venezuelensis, Bipolaris spp., Chaetomium spp., Farrowia spp., and Monocillium spp., in particular Aspergillus flavus and Aspergillus parasiticus (Plant Breeding (1999), 118, pp 1-16). There are also additional Aspergillus species known. The group of aflatoxins consists of more than 20 different toxins, in particular aflatoxin B1, B2, G1 and G2, cyclopiazonic acid (CPA).

Ochratoxins are toxins produced by some Aspergillus species and Penicilium species, like A. ochraceus, A. carbonarius or P. viridicaturn, Examples for Ochratoxins are ochratoxin A, B, and C. Ochratoxin A is the most prevalent and relevant fungal toxin of this group.

There is a need, therefore, to decrease the contamination by afla- and ochratoxins of plants and plant material before or after harvest or during storage.

Only very few reports can be found concerning the pre- and post harvest application of fungicides onto cereals, nuts, fruits and spices in order to reduce afla- or ochratoxin contamination.

The effect of fungicides on afla- and ochratoxin contamination in crops is discussed controversially as contradicting results are found. Disease development and afla- and ochratoxin production by the infecting fungi is influenced by a variety of factors not being limited to weather conditions, agricultural techniques, fungicide dose and application, growth stage of crops, colonization of crops by different fungi species, susceptibility of host crops and infection mode of fungi species.

It has also to be mentioned that breeding for fungal resistance in crops in contrast to insecticidal resistance is much more difficult. There have been several classical and transgenic breeding approaches, but obviously a high level of resistance is difficult to obtain.

Therefore application of fungicidal active compounds represents the most effective mode to control fungal infections of plants and thereby reducing afla- and ochratoxin content.

Therefore the problem to be solved by the present invention is to provide fungicidally active compounds which lead by their application on cereal, nut, fruit and spice plants and/or plant material from cereals, nuts, fruits and spices before or after harvest or during storage to a reduction of afla- and ochratoxin contamination in all plant and plant material.

Surprisingly it has now been found that the treatment of cereal, nut, fruit and spice plants and/or plant material from cereals, nuts, fruits and spices before or after harvest or during storage, in particular genetically modified cereals, nuts, fruits and spices with one or a combination of two or more fungicidal compounds selected from the group (I) comprising of (Ia) members of the azole group as Cyproconazole, Epoxiconazole, Flusilazole, Ipconazole, Propiconazole, Prothioconazole, Metconazole, Tebuconazole, Triadimenol, (Ib) members of the strobilurin group as Azoxystrobin, Fluoxastrobin, Kresoxim-methyl, Picoxystrobin, Pyraclostrobin, Trifloxystrobin, and (Ic) a group of other fungides as Boscalid, Chlorothalonil, Cyprodinil, Fludioxonil, Fluopyram, Myclobutonil, Prochloraz, Spiroxamine, N-(3′,4′-dichloro-5-fluoro[1,1′-biphenyl]-2-yl)-3-(difluoromethyl)-1-methyl-1H-pyrazole-4-carboxamide, 5-Chlor-6-(2,4,6-trifluorphenyl)-7-(4-methylpiperidin-1-yl) [1,2,4]triazolo[1,5-a]pyrimidin, 1-methyl-N-{2-[1′-methyl-1,1′-bi(cyclopropyl)-2-yl]phenyl}-3-(trifluoromethyl)-1H-pyrazole-4-carboxamide, N-{2-[1,1′-bi(cyclopropyl)-2-yl]phenyl}-1-methyl-3-(trifluoromethyl)-1H-pyrazole-4-carboxamide, 1-methyl-N-{2-[1′-methyl-1,1′-bi(cyclopropyl)-2-yl]phenyl}-3-(difluoromethyl)-1H-pyrazole-4-carboxamide, N-{2-[1,1′-bi(cyclopropyl)-2-yl]phenyl}-1-methyl-3-(difluoromethyl)-1H-pyrazole-4-carboxamide reduces afla- and ochratoxin contamination in the crop before or after harvest or during storage.

### DEFINITIONS

The fungicidal compound or the combination and/or composition according to the invention can be used curatively or preventively in order to reduce the afla- and ochratoxin contamination of cereal, nut, fruit and spice plants and/or plant material from cereals, nuts, fruits and spices before or after harvest or during storage, in particular genetically modified cereals, nuts, fruits and spices. Thus, according to a further aspect of the invention, there is provided a method for curatively or preventively reducing the afla- and ochratoxin contamination of cereals, nuts, fruits and spices comprising the use of one or a combination of two or more fungicidal compounds selected from the group (I) according to the invention by application to the seed, the plant or to the fruit of the plant or to the soil in which the plant is growing or in which it is desired to grow.

According to the invention the expression “combination” stands for the various combinations of two or more compounds from group (I), for example in a single “ready-mix” form, in a combined spray mixture composed from separate formulations of the single active compounds, such as a “tank-mix”, and in a combined use of the single active ingredients when applied in a sequential manner, i.e. one after the other with a reasonably short period, such as a few hours or days. Preferably the order of applying the compounds from group (I) is not essential for working the present invention.

According to the invention all cereal, nut, fruit and spice plants are comprised, in particular cereals like all wheat species, rye, barley, triticale, rice, sorghum, oats, millets, quinoa, buckwheat, fonio, amaranth, teff and durum; in particular fruits of various botanical taxa such as Rosaceae sp. (for instance pip fruit such as apples and pears, but also stone fruit such as apricots, cherries, almonds and peaches, berry fruits such as strawberries), Vitis sp. (for instance Vitis vinifera: grape vine, raisins), Manihoteae sp. (for instance Manihot esculenta, manioc), Theobroma sp. (for instance Theobroma cacao: cocoa), Ribesioidae sp., Juglandaceae sp., Betulaceae sp., Anacardiaceae sp., Fagaceae sp., Moraceae sp., Oleaceae sp., Actimidaceae sp., Lauraceae sp., Musaceaei sp. (for instance banana trees and plantings), Rubiaceae sp. (for instance coffee), Theaceae sp., Sterculiceae sp., Rutaceae sp. (for instance lemons, oranges and grapefruit); Solanaceae sp. (for instance tomatoes, potatoes, peppers, eggplant), Liliaceae sp.; in particular nuts of various botanical taxa such as peanuts, Juglandaceae sp. (Walnut, Persian Walnut (Juglans regia), Butternut (Juglans), Hickory, Shagbark Hickory, Pecan (Carya), Wingnut (Pterocarya)), Fagaceae sp. (Chestnut (Castanca), Chestnuts, including Chinese Chestnut, Malabar chestnut, Sweet Chestnut, Beech (Fagus), Oak (Quercus), Stone-oak, Tanoak (Lithocarpus)); Betulaceae sp. (Alder (Alnus), Birch (Betula), Hazel, Filbert (Corylus), Hornbeam), Leguminosae sp. (for instance peanuts, peas and beans beans—such as climbing beans and broad beans), Asteraceae sp. (for instance sunflower seed), Almond, Beech, Butternut, Brazil nut, Candlenut, Cashew, Colocynth, Cotton seed, Cucurbita ficifolia, Filbert, Indian Beech or Pongam Tree, Kola nut, Lotus seed, Macadamia, Mamoncillo, Maya nut, Mongongo, Oak acorns, Ogbono nut, Paradise nut, Pili nut, Pine nut, Pistacchio, Pumpkin seed, water Caltrop; soybeans (Glycine sp., Glycine max); in particular spices like Ajwain (Trachyspermum ammi), Allspice (Pimenta dioica), Alkanet (Anchusa arvensis), Amchur—mango powder (Mangifera), Angelica (Angelica archangelica), Anise (Pimpinella anisum), Aniseed myrtle (Syzygium anisatum), Annatto (Bixa orellana L.), Apple mint (Mentha suaveolens), Artemisia vulgaris/Mugwort, Asafoetida (Ferula assafoetida), Berberis, Banana, Basil (Ocimum basilicum), Bay leaves, Bistort (Persicaria bistorta”), Black cardamom, Black cumin, Blackcurrant, Black limes, Bladder wrack (Fucus vesiculosus), Blue Cohosh, Blue-leaved Mallee (Eucalyptus polybractea), Bog Labrador Tea (Rhododendron groenlandicum), Boldo (Peumus boldus), Bolivian Coriander (Porophyllum ruderale), Borage (Borago officinalis), Calamus, Calendula, Calumba (Jateorhiza calumba), Chamomile, Candle nut, Cannabis, Caper (Capparis spinosa), Caraway, Cardamom, Carob Pod, Cassia, Casuarina, Catnip, Cat's Claw, Catsear, Cayenne pepper, Celastrus Paniculatus—Herb., Celery salt, Celery seed, Centaury, Chervil (Anthriscus cerefolium), Chickweed, Chicory, Chile pepper, Chili powder, Cinchona, Chives (Allium schoenoprasum), Cicely (Myrrhis odorata), Cilantro (see Coriander) (Coriandrum sativum), Cinnamon (and Cassia), Cinnamon Myrtle (Backhousia myrtifolia), Clary, Cleavers, Clover, Cloves, Coffee, Coltsfoot, Comfrey, Common Rue, Condurango, Coptis, Coriander, Costmary (Tanacetum balsamita), Couchgrass, Cow Parsley (Anthriscus sylvestris), Cowslip, Cramp Bark (Viburnum opulus), Cress, Cuban Oregano (Plectranthus amboinicus), Cudweed, Cumin, Curry leaf (Murraya koenigii), Damiana (Turnera aphrodisiaca, T. diffuse), Dandelion (Taraxacum officinale), Demulcent, Devil's claw (Harpagophytum procumbens), Dill seed, Dill (Anethum graveolens), Dorrigo Pepper (Tasmannia stipitata), Echinacea—, Echinopanax Elatum, Edelweiss, Elderberry, Elderflower, Elecampane, Eleutherococcus senticosus, Emmenagogue, Epazote (Chenopodium ambrosioides), Ephedra—, Eryngium foetidum, Eucalyptus, Fennel (Foeniculum vulgare), Fenugreek, Feverfew, Figwort, Filé powder, Five-spice powder (Chinese), Fo-ti-tieng, Fumitory, Galangal, Guam masala, Garden cress, Garlic chives, Garlic, Ginger (Zingiber officinale), Ginkgo biloba, Ginseng, Ginseng, Siberian (Eleutherococcus senticosus), Goat's Rue (Galega officinalis), Goada masala, Golden Rod, Golden Seal, Gotu Kola, Grains of paradise (Aframomum melegueta), Grains of Selim (Xylopia aethiopica), Grape seed extract, Green tea, Ground Ivy, Guaco, Gypsywort, Hawthorn (Crataegus sanguinea), Hawthorne Tree, Hemp, Herbes de Provence, Hibiscus, Holly, Holy Thistle, Hops, Horehound, Horseradish, Horsetail (Equisetum telmateia), Hyssop (Hyssopus officinalis), Jalap, Jasmine, Jiaogulan (Gynostemma pentaphyllum), Joe Pye weed (Gravelroot), John the Conqueror, Juniper, Kaffir Lime Leaves (Citrus hystrix, C. papedia), Kaala masala, Knotweed, Kokam, Labrador tea, Lady's Bedstraw, Lady's Mantle, Land cress, Lavender (Lavandula spp.), Ledum, Lemon Balm (Melissa Officinalis), Lemon basil, Lemongrass (Cymbopogon citratus, C. flexuosus, and other species), Lemon Ironbark (Eucalyptus staigeriana), Lemon mint, Lemon Myrtle (Backhousia citriodora), Lemon Thyme, Lemon verbena (Lippia citriodora), Licorice—adaptogen, Lime Flower, Limnophila aromatica, Lingzhi, Linseed, Liquorice, Long pepper, Lovage (Levisticum officinale), Luohanguo, Mace, Mahlab, Malabathrum, Manchurian Thom Tree (Aralia manchurica)]], Mandrake, Marjoram (Origanum majorana), Marrubium vulgare, Marsh Labrador Tea, Marshmallow, Mastic, Meadowsweet, Mei Yen, Melegueta pepper (Aframomum melegueta), Mint (Mentha spp.), Milk thistle (Silybum), Bergamot (Monarda didyma), Motherwort, Mountain Skullcap, Mullein (Verbascum thapsus), Mustard, Mustard seed, Nashia inaguensis, Neem, Nepeta, Nettle, Nigella sativa, Nigella (Kolanji, Black caraway), Noni, Nutmeg (and Mace) Marijuana, Oenothera (Oenothera biennis et al), Olida (Eucalyptus olida), Oregano (Origanum vulgare, O. heracleoticum, and other species), Orris root, Osmorhiza, Olive Leaf (used in tea and as herbal supplement), Panax quinquefolius, Pandan leaf, Paprika, Parsley (Petroselinum crispum), Passion Flower, Patchouli, Pennyroyal, Pepper (black, white, and green), Peppermint, Peppermint Gum (Eucalyptus dives), Perilla, Plantain, Pomegranate, Ponch phoran, Poppy seed, Primrose (Primula)—candied flowers, tea, Psyllium, Purslane, Quassia, Quatre épices, Ramsons, Ras el-hanout, Raspberry (leaves), Reishi, Restharrow, Rhodiola rosea, Riberry (Syzygium luehmannii), Rocket/Arugula, Roman chamomile, Rooibos, Rosehips, Rosemary (Rosmarinus officinalis), Rowan Berries, Rue, Safflower, Saffron, Sage (Salvia officinalis), Saigon Cinnamon, St John's Wort, Salad Burnet (Sanguisorba minor or Poterium sanguisorba), Salvia, Sichuan Pepper (Sansho), Sassafras, Savory (Satureja hortensis, S. Montana), Schisandra (Schisandra chinensis), Scutellaria costaricana, Senna (herb), Senna obtusifolia, Sesame seed, Sheep Sorrel, Shepherd's Purse, Sialagogue, Siberian Chaga, Siberian ginseng (Eleutherococcus senticosus), Siraitia grosvenorii (luohanguo), Skullcap, Sloe Berries, Smudge Stick, Sonchus, Sorrel (Rumex spp.), Southernwood, Spearmint, Speedwell, Squill, Star anise, Stevia, Strawberry Leaves, Suma (Pfaffia paniculata), Sumac, Summer savory, Sutherlandia frutescens, Sweet grass, Sweet cicely (Myrrhis odorata), Sweet woodruff, Szechuan pepper (Xanthoxylum piperitum), Tacamahac, Tamarind, Tandoori masala, Tansy, Tarragon (Artemisia dracunculus), Tea, Teucrium polium, That basil, Thistle, Thyme, Toor Dall, Tormentil, Tribulus terrestris, Tulsi (Ocimum tenuiflorum), Turmeric (Curcuma longa), Uva Ursi also known as Bearberry, Vanilla (Vanilla planifolia), Vasaka, Vervain, Vetiver, Vietnamese Coriander (Persicaria odorata), Wasabi (Wasabia japonica), Watercress, Wattleseed, Wild ginger, Wild Lettuce, Wild thyme, Winter savory, Witch Hazel, Wolfberry, Wood Avens, Wood Betony, Woodruff, Wormwood, Yarrow, Yerba Buena, Yohimbe, Za'atar, Zedoary Root.

According to the invention cereals, nuts, fruits and spices includes all plant material of the species which is mentioned in the description above.

According to the invention all plants and plant material can be treated. By plants is meant all plants and plant populations such as desirable and undesirable wild plants, cultivars (including naturally occurring cultivars) and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods including transgenic plants.

By plant material is meant all above ground and below ground parts and organs of plants such as shoot, leaf, flower, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners, fruits, grains, pods, fruiting bodies, tubers and seedlings, and seeds also belong to plant parts.

According to the invention “before harvest” means the period of time starting from deploying the plant propagation material (e.g. seeds or seedlings) into an environment which supports plant growth (e.g. fields, greenhouses) until the plant or plant material is removed from this environment.

According to the invention the process of removing plant or plant material from the environment supporting plant growth is defined as “harvest”.

According to the invention “after harvest” means the period of time starting with the harvest of plant or plant material.

According to the invention “during storage” means the period of time in which the harvested plant or plant material is stored for further usages. It includes also further processing of the plant material for example drying or lyophilization of plant or plant material.

The fungicidal compound or compounds to be used in the treatment methods of the present invention include, but are not limited to group (I) comprising of (Ia) members of the azole group as Cyproconazole (113096-99-4), Epoxiconazole (106325-08-0), Flusilazole (85509-19-9), Ipconazole (125225-28-7), Propiconazole (60207-90-1), Prothioconazole (178928-70-6), Metconazole (125116-23-6), Tebuconazole (107534-96-3), Triadimenol (89482-17-7), (Ib) members of the strobilurin group as Azoxystrobin (131860-33-8), Fluoxastrobin (361377-29-9, Kresoxim-methyl (143390-89-0), Picoxystrobin (117428-22-5), Pyraclostrobin (175013-18-0), Trifloxystrobin (141517-21-7), and (Ic) a group of other fungicides as Boscalid (188425-85-6), Chlorothalonil (1897-45-6), Cyprodinil (121552-61-2), Fludioxonil (131341-86-1), Fluopyram (658066-35-4), Myclobutonil (88671-89-0), Prochloraz (67747-09-5), Spiroxamine (118134-30-8), N-(3′,4′-dichloro-5-fluoro[1,1′-biphenyl]-2-yl)-3-(difluoromethyl)-1-methyl-1H-pyrazole-4-carboxamide (Bixafen, 581809-46-3), 5-Chlor-6-(2,4,6-trifluorphenyl)-7-(4-methylpiperidin-1-yl) [1,2,4]triazolo[1,5-a]pyrimidin (214706-53-3), 1-methyl-N-{2-[1′-methyl-1,1′-bi(cyclopropyl)-2-yl]phenyl}-3-(trifluoromethyl)-1H-pyrazole-4-carboxamide (WO 2006/015865-A1), N-{2-[1,1′-bi(cyclopropyl)-2-yl]phenyl}-1-methyl-3-(trifluoromethyl)-1H-pyrazole-4-carboxamide (WO 2006/015865-A1), 1-methyl-N-{2-[1′-methyl-1,1′-bi(cyclopropyl)-2-yl]phenyl}-3-(difluoromethyl)-1H-pyrazole-4-carboxamide (WO 2006/015865-A1), N-{2-[1,1′-bi(cyclopropyl)-2-yl]phenyl}-1-methyl-3-(difluoromethyl)-1H-pyrazole-4-carboxamide (WO 2006/015865-A1).

These fungicidal compounds are characterized by their CAS-numbers or a PCT publication number in brackets behind the name:

The fungicide of the invention can be used in combination with at least one other fungicide of group (I).

In a particular embodiment, the fungicide is from the group (Ia) Cyproconazole, Epoxiconazole, Flusilazole, Ipconazole, Propiconazole, Prothioconazole, Metconazole, Tebuconazole, Triadimenol.

In a particular embodiment, the fungicide is from the group (Ia) Cyproconazole, Epoxiconazole, Ipconazole, Propiconazole, Prothioconazole, Metconazole, Tebuconazole.

In a particular embodiment, the fungicide is from the group (Ia) Epoxiconazole, Ipconazole, Prothioconazole, Tebuconazole.

In a particular embodiment, the fungicide is from the group (Ia) Prothioconazole, Tebuconazole

In a particular embodiment, the fungicide is from the group (Ib) Azoxystrobin, Fluoxastrobin, Picoxystrobin, Pyraclostrobin, Trifloxystrobin.

In a particular embodiment, the fungicide is from the group (Ib) Fluoxastrobin, Picoxystrobin, Pyraclostrobin, Trifloxystrobin.

In a particular embodiment, the fungicide is from the group (Ib) Trifloxystrobin.

In a particular embodiment, the fungicide is from the group (Ic) Boscalid, Chlorothalonil, Cyprodinil, Fludioxonil, Fluopyram, Myclobutonil, Prochloraz, Spiroxamine, N-(3′,4′-dichloro-5-fluoro[1,1′-biphenyl]-2-yl)-3-(difluoromethyl)-1-methyl-1H-pyrazole-4-carboxamide, 5-Chlor-6-(2,4,6-trifluorphenyl)-7-(4-methylpiperidin-1-yl) [1,2,4]triazolo[1,5-a]pyrimidin, 1-methyl-N-{2-[1′-methyl-1,1′-bi(cyclopropyl)-2-yl]phenyl}-3-(trifluoromethyl)-1H-pyrazole-4-carboxamide, N-{2-[1′-bi (cyclopropyl)-2-yl]phenyl}-1-methyl-3-(trifluoromethyl)-1H-pyrazole-4-carboxamide, 1-methyl-N-{2-[1′-methyl-1,1′-bi(cyclopropyl)-2-yl]phenyl}-3-(difluoromethyl)-1H-pyrazole-4-carboxamide, N-{2-[1,1′-bi(cyclopropyl)-2-yl]phenyl}-1-methyl-3-(difluoromethyl)-1H-pyrazole-4-carboxamide.

In a particular embodiment, the fungicide is from the group (Ic) Boscalid, Cyprodinil, Fludioxonil, Fluopyram, Myclobutonil, Prochloraz, Spiroxamine, N-(3′,4′-dichloro-5-fluoro[1,1′-biphenyl]-2-yl)-3-(difluoromethyl)-1-methyl-1H-pyrazole-4-carboxamide, 5-Chlor-6-(2,4,6-trifluorphenyl)-7-(4-methylpiperidin-1-yl)[1,2,4]-triazolo[1,5-a]pyrimidin.

In a particular embodiment, the fungicide is from the group (Ic) Boscalid, Cyprodinil, Fludioxonil, Fluopyram, N-(3′,4′-dichloro-5-fluoro[1,1′-biphenyl]-2-yl)-3-(difluoromethyl)-1-methyl-1H-pyrazole-4-carboxamide.

In a particular embodiment, the fungicide is from the group (Ia) Cyproconazole, Epoxiconazole, Ipconazole, Propiconazole, Prothioconazole, Metconazole, Tebuconazole or from group (Ib) members of the strobilurin group as Azoxystrobin, Fluoxastrobin, Picoxystrobin, Pyraclostrobin, Trifloxystrobin or from group (Ic) Boscalid, Cyprodinil, Fludioxonil, Fluopyram, Prochloraz, N-(3′,4′-dichloro-5-fluoro[1,1′-biphenyl]-2-yl)-3-(difluoromethyl)-1-methyl-1H-pyrazole-4-carboxamide, 5-Chlor-6-(2,4,6-trifluorphenyl)-7-(4-methylpiperidin-1-yl)[1,2,4]triazolo[1,5-a]pyrimidin.

In a very particular embodiment, the fungicide is from the group (Ia) Epoxiconazole, Ipconazole, Propiconazole, Prothioconazole, Metconazole, Tebuconazole or from group (Ib) members of the strobilurin group as Fluoxastrobin, Pyraclostrobin, Trifloxystrobin or and from group (Ic) Boscalid, Cyprodinil, Fludioxonil, Fluopyram, N-(3′,4′-dichloro-5-fluoro[1,1′-biphenyl]-2-yl)-3-(difluoromethyl)-1-methyl-1H-pyrazole-4-carboxamide.

In a very particular embodiment, the fungicide is from the group (Ia) Epoxiconazole, Ipconazole, Prothioconazole, Tebuconazole or from group (Ib) members of the strobilurin group as Trifloxystrobin, Picoxystrobin, Pyraclostrobin, Fluoxastrobin or from group (Ic) Cyprodinil, Fludioxonil.

In a very particular embodiment, the fungicide is from the group (Ia) Prothioconazole, Tebuconazole or from group (Ib) members of the strobilurin group as Trifloxystrobin.

In a particular embodiment, the active compound combinations are comprising of one fungicide from group (Ia) and one fungicide of group (Ib).

In a particular embodiment, the active compound combinations are comprising of one fungicide from group (Ia) and one fungicide of group (Ic).

In a particular embodiment, the active compound combinations are comprising of one fungicide from group (Ib) and one fungicide of group (Ic).

In a particular embodiment, the active compound combinations are comprising of more than one fungicide from group (Ia).

In a particular embodiment, the active compound combinations are comprising of more than one fungicide from group (Ib).

In a particular embodiment, the active compound combinations are comprising of more than one fungicide from group (Ic).

Very particular preference is given to combinations comprising one fungicide from group (Ia) Cyproconazole, Epoxiconazole, Flusilazole, Ipconazole, Propiconazole, Prothioconazole, Metconazole, Tebuconazole, Triadimenol and one fungicide of group (Ib) Azoxystrobin, Fluoxastrobin, Kresoxim-methyl, Picoxystrobin, Pyraclostrobin, Trifloxystrobin.

Very particular preference is given to combinations comprising one fungicide from group (Ia) Epoxiconazole, Ipconazole, Propiconazole, Prothioconazole, Metconazole, Tebuconazole and one fungicide of group (Ib) Azoxystrobin, Fluoxastrobin, Pyraclostrobin, Trifloxystrobin.

Very particular preference is given to combinations comprising one fungicide from group (Ia) Prothioconazole, Tebuconazole and one fungicide of group (Ib) Trifloxystrobin.

Particularly preferred combinations comprising of two fungicides are listed below:

### Epoxiconazole and Azoxystrobin,

### Ipconazole and Azoxystrobin,

### Propiconazole and Azoxystrobin,

### Prothioconazole and Azoxystrobin,

### Metconazole and Azoxystrobin,

### Tebuconazole and Azoxystrobin,

### Epoxiconazole and Pyraclostrobin,

### Ipconazole and Pyraclostrobin,

### Propiconazole and Pyraclostrobin,

### Prothioconazole and Pyraclostrobin,

### Metconazole and Pyraclostrobin,

### Tebuconazole and Pyraclostrobin,

### Epoxiconazole and Fluoxastrobin,

### Ipconazole and Fluoxastrobin,

### Propiconazole and Fluoxastrobin,

### Prothioconazole and Fluoxastrobin,

### Metconazole and Fluoxastrobin,

### Tebuconazole and Fluoxastrobin,

### Epoxiconazole and Trifloxystrobin,

### Ipconazole and Trifloxystrobin,

### Propiconazole and Trifloxystrobin,

### Prothioconazole and Trifloxystrobin,

### Metconazole and Trifloxystrobin,

### Tebuconazole and Trifloxystrobin,

### Fludioxonil und Myclobutanil.

### Epoxiconazole and Ipconazole,

### Propiconazole and Ipconazole,

### Prothioconazole and Ipconazole,

### Metconazole and Ipconazole,

### Tebuconazole and Ipconazole,

### Epoxiconazole and Propiconazole,

### Prothioconazole and Propiconazole,

### Metconazole and Propiconazole,

### Tebuconazole and Propiconazole,

### Epoxiconazole and Prothioconazole,

### Metconazole and Prothioconazole,

### Tebuconazole and Prothioconazole,

### Epoxiconazole and Metconazole,

### Tebuconazole and Metconazole,

### Epoxiconazole and Tebuconazole.

If the compounds in the active compound combinations according to the invention are present in certain weight ratios, the afla- and ochratoxin-reducing effect is particularly pronounced. However, the weight ratios of the active compounds in the active compound combinations can be varied within a relatively wide range. In general, in the combinations according to the invention the compounds selected from group (I) are present in a synergistically effective weight ratio of the first to the second compound in a range of 100:1 to 1:100, preferably in a weight ratio of 50:1 to 1:50, most preferably in a weight ratio of 20:1 to 1:20.

According to the invention the expression “combination” stands for the various combinations of compounds of group (I), for example in a single “ready-mix” form, in a combined spray mixture composed from separate formulations of the single active compounds, such as a “tank-mix”, and in a combined use of the single active ingredients when applied in a sequential manner, i.e. one after the other with a reasonably short period, such as a few hours or days. Preferably the order of applying the compounds of group (I) is not essential for working the present invention.

In a particular embodiment the fungi producing the afla- and ochratoxins are selected from the group of the following species: Aspergillus flavus, Aspergillus parasiticus and Aspergillus nomius, A. ochraceus, A. carbonarius or P. viridicatum.

In a very particular embodiment the fungi producing the afla- and ochratoxins are selected from the group of the following species:

Aspergillus flavus, Aspergillus parasiticus strains and Apergillus nomius, A. ochraceus, A. carbonarius.

In a particular embodiment the afla- and ochratoxins are selected from the following group: aflatoxins B1, B2, G1 and G2, ochratoxin A, B, C.

In a very particular embodiment the afla- and ochratoxins are selected from the following group: aflatoxins B1, B2, G1 and G2.

In a very particular embodiment the afla- and ochratoxins are selected from the following group: ochratoxin A, B, C.

In a particular embodiment of the invention plant or plant material before or after harvest or during storage has at least 10% less afla- and ochratoxin, more preferable at least 20% afla- and ochratoxin, more preferable at least 40% afla- and ochratoxin, more preferable at least 50% afla- and ochratoxin, more preferable at least 80% afla- and ochratoxin contamination than plant or plant material before or after harvest or during storage which has not been treated.

In a particular embodiment of the invention plant or plant material before or after harvest or during storage has at least 10% less aflatoxin, more preferable at least 20% aflatoxin, more preferable at least 40% aflatoxin, more preferable at least 50% aflatoxin, more preferable at least 80% aflatoxin contamination than plant or plant material before or after harvest or during storage which has not been treated.

In a particular embodiment of the invention plant or plant material before or after harvest or during storage has at least 10% less ochratoxin, more preferable at least 20% ochratoxin, more preferable at least 40% ochratoxin, more preferable at least 50% ochratoxin, more preferable at least 80% ochratoxin contamination than plant or plant material before or after harvest or during storage which has not been treated.

In a particular embodiment the plants are selected from the group of wheat species, rye, barley, triticale, rice, sorghum, oats, millets, quinoa, buckwheat, amaranth, apples, pears, apricots, cherries, almonds, peaches, berry fruits, grape vine, raisins), manioc, cocoa, Musaceae sp. (for instance banana trees and plantings), coffee, Theaceae sp., lemons, oranges and grapefruit, tomatoes, potatoes, peppers, eggplant; peanuts, Juglandaceae sp. (Walnut, Persian Walnut (Juglans regia), Hickory, Fagaceae sp. (Chestnut (Castanea), Chestnuts, including Chinese Chestnut, Malabar chestnut, Sweet Chestnut, Hazel, Leguminosae sp. (for instance peanuts, peas and beans beans—such as climbing beans and broad beans), Asteraceae sp. (for instance sunflower seed), Almond, Cashew, Cotton seed, Macadamia, Pine nut, Pistacchio, soybeans (Glycine sp., Glycine max); Cardamom, Cinnamon (and Cassia), Coriander, Cumin, Garlic, Ginger (Zingiber officinale), Green tea, Horseradish, Lavender (Lavandula spp.), Mint (Mentha spp.), Paprika, Parsley (Petroselinum crispum), Pepper (black, white, and green), Peppermint, Primrose (Primula)—candied flowers, tea, Rosemary (Rosmarinus officinalis), Sage (Salvia officinalis), Salvia, Sesame seed, Vanilla (Vanilla planifolia).

In a very particular embodiment the plants are selected from the group of rice, peanuts, cashews, cocoa, raisins, grapes, soybeans, manioc, cotton seed.

Treatment of plant and plant material before or after harvest or during storage can also involve treatment with further active compounds in combination with the active compounds of the present invention, which treatment may be applied together and/or sequentially in its commercially available formulations and in the use forms, prepared from these formulations.

These further compounds can be insecticides, attractants, sterilizing agents, bactericides, acaricides, nematicides, fungicides, growth-regulating substances, herbicides, safeners, fertilizers, inoculants or other plant-growth influencing compounds or semiochemicals.

A particularly effective treatment for cereals, nuts, fruits and spices is a combination comprising a) Prothioconazole and Trifloxystrobin or b) Tebuconazole and Trifloxystrobin or c) Tebuconazole and Prothioconazole.

The method of treatment according to the invention is used in the treatment of genetically modified organisms (GMOs), e.g. plants or seeds. Genetically modified plants (or transgenic plants) are plants of which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, co-suppression technology or RNA interference—RNAi—technology). A heterologous gene that is located in the genome is also called a transgene. A transgene that is defined by its particular location in the plant genome is called a transformation or transgenic event.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the active compounds and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability and/or processability of the harvested products are possible, which exceed the effects which were actually to be expected.

Plants and plant cultivars which are preferably to be treated according to the invention include all plants which have genetic material which impart particularly advantageous, useful traits to these plants (whether obtained by breeding and/or biotechnological means).

Plants and plant cultivars which are also preferably to be treated according to the invention are resistant against one or more biotic stresses, i.e. said plants show a better defense against animal and microbial pests, such as against nematodes, insects, mites, phytopathogenic fungi, bacteria, viruses and/or viroids.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may be treated according to the invention are hybrid plants that already express the characteristic of heterosis or hybrid vigor which results in generally higher yield, vigor, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling, i.e. the mechanical removal of the male reproductive organs (or males flowers) but, more typically, male sterility is the result of genetic determinants in the plant genome. In that case, and especially when seed is the desired product to be harvested from the hybrid plants it is typically useful to ensure that male fertility in the hybrid plants is fully restored. This can be accomplished by ensuring that the male parents have appropriate fertility restorer genes which are capable of restoring the male fertility in hybrid plants that contain the genetic determinants responsible for male-sterility. Genetic determinants for male sterility may be located in the cytoplasm. Examples of cytoplasmic male sterility (CMS) were for instance described in Brassica species. However, genetic determinants for male sterility can also be located in the nuclear genome. Male sterile plants can also be obtained by plant biotechnology methods such as genetic engineering. A particularly useful means of obtaining male-sterile plants is described in WO 89/10396 in which, for example, a ribonuclease such as barnase is selectively expressed in the tapetum cells in the stamens. Fertility can then be restored by expression in the tapetum cells of a ribonuclease inhibitor such as barstar.

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. Plants can be made tolerant to glyphosate through different means. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium, the CP4 gene of the bacterium Agrobacterium sp, the genes encoding a Petunia EPSPS, a Tomato EPSPS, or an Eleusine EPSPS. It can also be a mutated EPSPS. Glyphosate-tolerant plants can also be obtained by expressing a gene that encodes a glyphosate oxido-reductase enzyme. Glyphosate-tolerant plants can also be obtained by expressing a gene that encodes a glyphosate acetyl transferase enzyme. Glyphosate-tolerant plants can also be obtained by selecting plants containing naturally-occurring mutations of the above-mentioned genes.

Other herbicide resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is an enzyme encoding a phosphinothricin acetyltransferase (such as the bar or pat protein from Streptomyces species). Plants expressing an exogenous phosphinothricin acetyltransferase are also described.

Further herbicide-tolerant plants are also plants that are made tolerant to the herbicides inhibiting the enzyme hydroxyphenylpyruvatedioxygenase (HPPD). Hydroxyphenylpyruvatedioxygenases are enzymes that catalyze the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated HPPD enzyme. Tolerance to HPPD-inhibitors can also be obtained by transforming plants with genes encoding certain enzymes enabling the formation of homogentisate despite the inhibition of the native HPPD enzyme by the HPPD-inhibitor. Tolerance of plants to HPPD inhibitors can also be improved by transforming plants with a gene encoding an enzyme prephenate dehydrogenase in addition to a gene encoding an HPPD-tolerant enzyme.

Still further herbicide resistant plants are plants that are made tolerant to acetolactate synthase (ALS) inhibitors. Known ALS-inhibitors include, for example, sulfonylurea, imidazolinone, triazolopyrimidines, pyrimidinyoxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides. The production of sulfonylurea-tolerant plants and imidazolinone-tolerant plants is describe. Other imidazolinone-tolerant plants are also described. Further sulfonylurea- and imidazolinone-tolerant plants are also described in for example WO 2007/024782.

Other plants tolerant to imidazolinone and/or sulfonylurea can be obtained by induced mutagenesis, selection in cell cultures in the presence of the herbicide or mutation breeding as described for example for soybeans, for rice, for sugar beet, for lettuce, or for sunflower.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) at the Bacillus thuringiensis toxin nomenclature, online at: http://www.lifesci.sussex.ac.uk/Home/Neil_Crickmore/Bt/), or insecticidal portions thereof, e.g., proteins of the Cry protein classes Cry1Ab, Cry1Ac, Cry1F, Cry2Ab, Cry3Aa, or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cry34 and Cry35 crystal proteins; or
3) a hybrid insecticidal protein comprising parts of different insecticidal crystal proteins from Bacillus thuringiensis, such as a hybrid of the proteins of 1) above or a hybrid of the proteins of 2) above, e.g., the C 1A.105 protein produced by corn event MON98034; or
4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604;
5) an insecticidal secreted protein from Bacillus thuringiensis or Bacillus cereus, or an insecticidal portion thereof, such as the vegetative insecticidal (VIP) proteins listed at:
   http://www.lifesci.sussex.ac.uk/home/Neil_Crickmore/Bt/vip e.g., proteins from the VIP3Aa protein class; or
6) secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins; or
7) hybrid insecticidal protein comprising parts from different secreted proteins from Bacillus thuringiensis or Bacillus cereus, such as a hybrid of the proteins in 1) above or a hybrid of the proteins in 2) above; or
8) protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102.

Of course, an insect-resistant transgenic plant, as used herein, also includes any plant comprising a combination of genes encoding the proteins of any one of the above classes 1 to 8. In one embodiment, an insect-resistant plant contains more than one transgene encoding a protein of any one of the above classes 1 to 8, to expand the range of target insect species affected when using different proteins directed at different target insect species, or to delay insect resistance development to the plants by using different proteins insecticidal to the same target insect species but having a different mode of action, such as binding to different receptor binding sites in the insect.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance. Particularly useful stress tolerance plants include:
a. plants which contain a transgene capable of reducing the expression and/or the activity of poly(ADP-ribose)polymerase (PARP) gene in the plant cells or plants
b. plants which contain a stress tolerance enhancing transgene capable of reducing the expression and/or the activity of the PARG encoding genes of the plants or plants cells.
c. plants which contain a stress tolerance enhancing transgene coding for a plant-functional enzyme of the nicotinamide adenine dinucleotide salvage synthesis pathway including nicotinamidase, nicotinate phosphoribosyltransferase, nicotinic acid mononucleotide adenyl transferase, nicotinamide adenine dinucleotide synthetase or nicotine amide phosphorybosyltransferase.

Examples of plants with the above-mentioned traits are non-exhaustively listed in Table A.

TABLE A

| | Effected target or expressed | |
|---|---|---|
| No. | principle(s) | Crop phenotype/Tolerance to |
| A-1 | Acetolactate synthase (ALS) | Sulfonylureas, Imidazolinones, Triazolopyrimidines, |
| | | Pyrimidyloxybenzoates, Phtalides |
| A-2 | AcetylCoA Carboxylase (ACCase) | Aryloxyphenoxyalkanecarboxylic acids, cyclohexanediones |
| A-3 | Hydroxyphenylpyruvate dioxygenase | Isoxazoles such as Isoxaflutol or Isoxachlortol, Triones such as |
| | (HPPD) | mesotrione or sulcotrione |
| A-4 | Phosphinothricin acetyltransferase | Phosphinothricin |
| A-5 | O-Methyl transferase | altered lignin levels |
| A-6 | Glutamine synthetase | Glufosinate, Bialaphos |
| A-7 | Adenylosuccinate Lyase (ADSL) | Inhibitors of IMP and AMP synthesis |
| A-8 | Adenylosuccinate Synthase | Inhibitors of adenylosuccinate synthesis |
| A-9 | Anthranilate Synthase | Inhibitors of tryptophan synthesis and catabolism |
| A-10 | Nitrilase | 3,5-dihalo-4-hydroxy-benzonitriles such as Bromoxynil and |
| | | Ioxinyl |
| A-11 | 5-Enolpyruvyl-3phosphoshikimate | Glyphosate or sulfosate |
| | Synthase (EPSPS) | |
| A-12 | Glyphosate oxidoreductase | Glyphosate or sulfosate |
| A-13 | Protoporphyrinogen oxidase (PROTOX) | Diphenylethers, cyclic imides, phenylpyrazoles, pyridin |
| | | derivatives, phenopylate, oxadiazoles, etc. |
| A-14 | Cytochrome P450 eg. P450 SUI | Xenobiotics and herbicides such as Sulfonylureas |
| A-15 | Dimboa biosynthesis (Bxl gene) | Helminthosporium turcicum, Rhopalosiphum maydis, Diplodia |
| | | maydis, Ostrinia nubilalis, lepidoptera sp. |
| A-16 | CMIII (small basic maize seed peptide) | plant pathogenes eg. fusarium, alternaria, sclerotina |
| A-17 | Corn-SAFP (zeamatin) | plant pathogenes eg. fusarium, alternaria, sclerotina, rhizoctonia, |
| | | chaetomium, phycomyces |
| A-18 | Hml gene | Cochliobulus |
| A-19 | Chitinases | plant pathogenes |
| A-20 | Glucanases | plant pathogenes |
| A-21 | Coat proteins | viruses such as maize dwarf mosaic virus, maize chlorotic dwarf |
| | | virus |
| A-22 | Bacillus thuringiensis toxins, VIP 3, | lepidoptera, coleoptera, diptera, nematodes, eg. ostrinia nubilalis, |
| | Bacillus cereus toxins, Photorabdus and | heliothis zea, armyworms eg. Spodoptera frugiperda, corn |
| | Xenorhabdus toxins | rootworms, sesamia sp., black cutworm, asian corn borer, weevils |
| A-23 | 3-Hydroxysteroid oxidase | lepidoptera, coleoptera, diptera, nematodes, eg. ostrinia nubilalis, |
| | | heliothis zea, armyworms eg. Spodoptera frugiperda, corn |
| | | rootworms, sesamia sp., black cutworm, asian corn borer, weevils |
| A-24 | Peroxidase | lepidoptera, coleoptera, diptera, nematodes, eg. ostrinia nubilalis, |
| | | heliothis zea, armyworms eg. spodoptera frugiperda, corn |
| | | rootworms, sesamia sp., black cutworm, asian corn borer, weevils |
| A-25 | Aminopeptidase inhibitors eg. Leucine | lepidoptera, coleoptera, diptera, nematodes, eg. ostrinia nubilalis, |
| | aminopeptidase inhibitor (LAPI) | heliothis zea, armyworms eg. spodoptera frugiperda, corn |
| | | rootworms, sesamia sp., black cutworm, asian corn borer, weevils |
| A-26 | Limonene synthase | corn rootworms |
| A-27 | Lectines | lepidoptera, coleoptera, diptera, nematodes, eg. ostrinia nubilalis, |
| | | heliothis zea, armyworms eg. spodoptera frugiperda, corn |
| | | rootworms, sesamia sp., black cutworm, asian corn borer, weevils |
| A-28 | Protease Inhibitors eg. cystatin, patatin, | weevils, corn rootworm |
| | virgiferin, CPTI | |
| A-29 | ribosome inactivating protein | lepidoptera, coleoptera, diptera, nematodes, eg. ostrinia nubilalis, |
| | | heliothis zea, armyworms eg. spodoptera frugiperda, corn |
| | | rootworms, sesamia sp., black cutworm, asian corn borer, weevils |
| A-30 | maize 5C9 polypeptide | lepidoptera, coleoptera, diptera, nematodes, eg. ostrinia nubilalis, |
| | | heliothis zea, armyworms eg. spodoptera frugiperda, corn |
| | | rootworms, sesamia sp., black cutworm, asian corn borer, weevils |
| A-31 | HMG-CoA reductase | lepidoptera, coleoptera, diptera, nematodes, eg. ostrinia nubilalis, |
| | | heliothis zea, armyworms eg. spodoptera frugiperda, corn |
| | | rootworms, sesamia sp., black cutworm, asian corn borer, weevils |
| A-32 | Inhibition of protein synthesis | Chloroactanilides such as Alachlor, Acetochlor, Dimethenamid |
| A-33 | Hormone mimic | 2,4-D, Mecoprop-P |

Plants or plant cultivars (obtained by plant biotechnology methods such as genetic engineering) which may also be treated according to the invention show altered quantity, quality and/or storage-stability of the harvested product and/or altered properties of specific ingredients of the harvested product such as:
1) transgenic plants which synthesize a modified starch, which in its physical-chemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesised starch in wild type plant cells or plants, so that this is better suited for special applications.
2) transgenic plants which synthesize non starch carbohydrate polymers or which synthesize non starch carbohydrate polymers with altered properties in comparison to wild type plants without genetic modification. Examples are plants producing polyfructose, especially of the inulin and levan-type, plants producing alpha 1,4 glucans, plants producing alpha-1,6 branched alpha-1,4-glucans, plants producing alternan,
3) transgenic plants which produce hyaluronan.

Particularly useful transgenic plants which may be treated according to the invention are plants containing transformation events, or combination of transformation events, that are the subject of petitions for non-regulated status, in the United States of America, to the Animal and Plant Health Inspection Service (APHIS) of the United States Department of Agriculture (USDA) whether such petitions are granted or are still pending. At any time this information is readily available from APHIS (4700 River Road Riverdale, Md. 20737, USA), for instance on its internet site (URL http://www.aphis.usda.gov/brs/notreg.html). On the filing date of this application the petitions for nonregulated status that were pending with APHIS or granted by APHIS were those listed in table B which contains the following information:

Petition: the identification number of the petition. Technical descriptions of the transformation events can be found in the individual petition documents which are obtainable from APHIS, for example on the APHIS website, by reference to this petition number. These descriptions are herein incorporated by reference.
Extension of Petition: reference to a previous petition for which an extension is requested.
Institution: the name of the entity submitting the petition.
Regulated article: the plant species concerned.
Transgenic phenotype: the trait conferred to the plants by the transformation event.
Transformation event or line: the name of the event or events (sometimes also designated as lines or lines) for which nonregulated status is requested.
APHIS documents: various documents published by APHIS in relation to the Petition and which can be requested with APHIS.

| | | Extension | | | | | | Preliminary EA | |
|---|---|---|---|---|---|---|---|---|---|
| | | of Petition | | | | | | **** or Risk | Final EA |
| | Petition | Number *** | Institution | Regulated Article | Transgenic Phenotype | Transformation Event or Line | FR Notices | Assessment | & Determination |
| B-2 | 07-180-01p | | Florigene | Carnation | Altered Flower Color | IFD-1989Ø- | | | |
| | | | | | | 1 & IFD- | | | |
| | | | | | | 199Ø7-9 | | | |
| B-4 | 07-108-01p | | Syngenta | Cotton Soybean | Lepidopteran Resistant | COT67B | | | |
| B-5 | 06-354-01p | | Pioneer | | High Oleic Acid | DP-3Ø5423-1 | | | |
| B-6 | 06-332-01p | | Bayer | Cotton | Glyphosate tolerant | GHB614 | | | |
| | | | CropScience | | | | | | |
| B-8 | 06-271-01p | | Pioneer | Soybean | Glyphosate & acetolactate synthase | 356043 | 5-Oct-2007 | 06-271-01p_pea | |
| | | | | | tolerant | | | | |
| B-10 | 04-337-01p | | University | Papaya | Papaya Ringspot Virus Resistant | X17-2 | | | |
| | | | of Florida | | | | | | |
| B-11 | 04-110-01p | | Monsanto | Alfalfa | Glyphosate Tolerant | J101, J163 | 23-Mar-2007; | 04-110-01p_pea | 04-110-01p_com |
| | | | & Forage | | | | 27.06.2005; | | |
| | | | Genetics | | | | 03.02.2005; 24.11.2004 | | |
| B-12 | 03-104-01p | | Monsanto | Creeping | Glyphosate Tolerant | ASR368 | Scoping & Status; | 03-104-01p_ra & | |
| | | | & Scotts | bentgrass | | | 12-Oct-2005; | CBG White Paper | |
| | | | | | | | 11.04.2005; | | |
| | | | | | | | 18.11.2004; | | |
| | | | | | | | 24.09.2004; | | |
| | | | | | | | 05.01.2004 | | |
| B-13 | 06-234-01p | 98-329-01p | Bayer | Rice | Phosphinothricin tolerant | LLRICE601 | 4-Dec-2006; | 06-234-01p_pea | 06-234-01p_com |
| | | | CropScience | | | | 08.09.2006 | | |
| B-14 | 06-178-01p | | Monsanto | Soybean | Glyphosate tolerant | MON | 02.08.2007; | 06-178-01p_pea | 06-178-01p_com |
| | | | | | | 89788 | 05.02.2007 | | |
| B-16 | 04-264-01p | | ARS | Plum | Plum Pox Virus Resistant | C5 | 13-July-2007; 16- | 04-264-01p_pea | 04-264-01p_com |
| | | | | | | | May-2006 | | |
| B-21 | 03-323-01p | | Monsanto | Sugar Beet | Glyphosate Tolerant | H7-1 | 17-Mar-2005; 19- | 03-323-01p_pea | 03-323-01p_com |
| | | | | | | | Oct-2004 | | |
| B-23 | 03-155-01p | | Syngenta | Cotton | Lepidopteran Resistant | COT 102 | 20.07.2005; | 03-155-01p_pea | 03-155-01p_com |
| | | | | | | | 28.01.2005 | | |
| B-24 | 03-036-01p | | Mycogen/Dow | Cotton | Lepidopteran Resistant | 281-24-236 | 13.08.2004; 9-Mar- | 03-036-01p_pea | 03-036-01p_com |
| | | | | | | | 2004 | | |
| B-25 | 03-036-02p | | Mycogen/Dow | Cotton | Lepidopteran Resistant | 3006-210- | 13.08.20049-Mar- | 03-036-02p_pea | 03-036-02p_com |
| | | | | | | 23 | 2004 | | |
| B-26 | 02-042-01p | | Aventis | Cotton | Phosphinothericin tolerant | LLCotton25 | | | 02-042-01p_com |
| B-27 | 01-324-01p | 98-216- | Monsanto | Rapeseed | Glyphosate tolerant | RT200 | | | 01-324-01p_com |
| | | 01p | | | | | | | |
| B-28 | 01-206-01p | 98-278- | Aventis | Rapeseed | Phosphinothricin tolerant & | MS1 & | | | 01-206-01p_com |
| | | 01p | | | pollination control | RF1/RF2 | | | |
| B-29 | 01-206-02p | 97-205- | Aventis | Rapeseed | Phosphinothricin tolerant | Topas 19/2 | | | 01-206-02p_com |
| | | 01p | | | | | | | |
| B-31 | 01-121-01p | | Vector | Tobacco | Reduced nicotine | Vector 21-41 | | | 01-121-01p_com |
| B-32 | 00-342-01p | | Monsanto | Cotton | Lepidopteran resistant | Cotton | | | 00-342-01p_com |
| | | | | | | Event | | | |
| | | | | | | 15985 | | | |
| B-35 | 99-173-01p | 97-204- | Monsanto | Potato | PLRV & CPB resistant | RBMT22- | | | 99-173-01p_com |
| | | 01p | | | | 82 | | | |
| B-37 | 98-335-01p | | U. of | Flax | Tolerant to soil residues of sulfonyl | CDC Triffid | | | 98-335-01p_com |
| | | | Saskatchewan | | urea herbicide | | | | |
| B-38 | 98-329-01p | | AgrEvo | Rice | Phosphinothricin tolerant | LLRICE06, | | | 98-329-01p_com |
| | | | | | | LLRICE62 | | | |
| B-39 | 98-278-01p | | AgrEvo | Rapeseed | Phosphinothricin tolerant & | MS8 & RF3 | | | 98-278-01p_com |
| | | | | | Pollination control | | | | |
| B-40 | 98-238-01p | | AgrEvo | Soybean | Phosphinothricin tolerant | GU262 | | | 98-238-01p_com |
| B-41 | 98-216-01p | | Monsanto | Rapeseed | Glyphosate tolerant | RT73 | | | 98-216-01p_com |
| B-42 | 98-173-01p | | Novartis | Beet | Glyphosate tolerant | GTSB77 | | | 98-173-01p_com |
| | | | Seeds & | | | | | | |
| | | | Monsanto | | | | | | |
| B-43 | 98-014-01p | 96-068- | AgrEvo | Soybean | Phosphinothricin tolerant | A5547-127 | | | 98-014-01p_com |
| | | 01p | | | | | | | |
| B-45 | 97-339-01p | | Monsanto | Potato | CPB & PVY resistant | RBMT15- | | | 97-339-01p_com |
| | | | | | | 101, | | | |
| | | | | | | SEMT15- | | | |
| | | | | | | 02, | | | |
| | | | | | | SEMT15-15 | | | |
| B-46 | 97-336-01p | | AgrEvo | Beet | Phosphinothricin tolerant | T-120-7 | | | 97-336-01p_com |
| B-47 | 97-287-01p | | Monsanto | Tomato | Lepidopteran resistant | 5345 | | | 97-287-01p_com |
| B-49 | 97-205-01p | | AgrEvo | Rapeseed | Phosphinothricin tolerant | T45 | | | 97-205-01p_com |
| B-50 | 97-204-01p | | Monsanto | Potato | CPB & PLRV resistant | RBMT21- | | | 97-204-01p_com |
| | | | | | | 129 & | | | |
| | | | | | | RBMT21- | | | |
| | | | | | | 350 | | | |
| B-51 | 97-148-01p | | Bejo | Cichorium | Male sterile | RM3-3, | | | 97-148-01p_com |
| | | | | intybus | | RM3-4, | | | |
| | | | | | | RM3-6 | | | |
| B-53 | 97-013-01p | | Calgene | Cotton | Bromoxynil tolerant & | Events | | | 97-013-01p_com |
| | | | | | Lepidopteran resistant | 31807 & | | | |
| | | | | | | 31808 | | | |
| B-54 | 97-008-01p | | Du Pont | Soybean | Oil profile altered | G94-1, | | | 97-008-01p_com |
| | | | | | | G94-19, G- | | | |
| | | | | | | 168 | | | |
| B-57 | 96-248-01p | 92-196- | Calgene | Tomato | Fruit ripening altered | 1 additional | | | 96-248-01p_com |
| | | 01p | | | | FLAVRSAVR | | | |
| | | | | | | line | | | |
| B-58 | 96-068-01p | | AgrEvo | Soybean | Phosphinothricin tolerant | W62, W98, | | | 96-068-01p_com |
| | | | | | | A2704-12, | | | |
| | | | | | | A2704-21, | | | |
| | | | | | | A5547-35 | | | |
| B-59 | 96-051-01p | | Cornell U | Papaya | PRSV resistant | 55-1, 63-1 | | | 96-051-01p_com |
| B-61 | 95-352-01p | | Asgrow | Squash | CMV, ZYMV, WMV2 resistant | CZW-3 | | | 95-352-01p_com |
| B-62 | 95-338-01p | | Monsanto | Potato | CPB resistant | SBT02-5 & | | | 95-338-01p_com |
| | | | | | | -7, | | | |
| | | | | | | ATBT04-6 | | | |
| | | | | | | &-27, -30, - | | | |
| | | | | | | 31, -36 | | | |
| B-63 | 95-324-01p | | Agritope | Tomato | Fruit ripening altered | 35 1 N | | | 95-324-01p_com |
| B-64 | 95-256-01p | | Du Pont | Cotton | Sulfonylurea tolerant | 19-51a | | | 95-256-01p_com |
| B-67 | 95-179-01p | 92-196- | Calgene | Tomato | Fruit ripening altered | 2 additional | | | 95-179-01p_com |
| | | 01p | | | | FLAVRSAVR | | | |
| | | | | | | lines | | | |
| B-70 | 95-053-01p | | Monsanto | Tomato | Fruit ripening altered | 8338 | | | 95-053-01p_com |
| B-71 | 95-045-01p | | Monsanto | Cotton | Glyphosate tolerant | 1445, 1698 | | | 95-045-01p_com |
| B-72 | 95-030-01p | 92-196- | Calgene | Tomato | Fruit ripening altered | 20 | | | 95-030-01p_com |
| | | 01p | | | | additional | | | |
| | | | | | | FLAVRSAVR | | | |
| | | | | | | lines | | | |
| B-75 | 94-308-01p | | Monsanto | Cotton | Lepidopteran resistant | 531, 757, | | | 94-308-01p_com |
| | | | | | | 1076 | | | |
| B-76 | 94-290-01p | | Zeneca & | Tomato | Fruit polygalacturonase level | B, Da, F | | | 94-290-01p_com |
| | | | Petoseed | | decreased | | | | |
| B-77 | 94-257-01p | | Monsanto | Potato | Coleopteran resistant | BT6, BT10, | 10-Mar-1995 | 94-257-01p_ea | 94-257-01p_com |
| | | | | | | BT12, | | | |
| | | | | | | BT16, | | | |
| | | | | | | BT17, | | | |
| | | | | | | BT18, BT23 | | | |
| B-78 | 94-230-01p | 92-196- | Calgene | Tomato | Fruit ripening altered | 9 additional | | | 94-230-01p_com |
| | | 01p | | | | FLAVRSAVR | | | |
| | | | | | | lines | | | |
| B-79 | 94-228-01p | | DNA Plant | Tomato | Fruit ripening altered | 1345-4 | 24. Jan 95 | 94-228-01p_ea | 94-228-01p_com |
| | | | Tech | | | | | | |
| B-80 | 94-227-01p | 92-196- | Calgene | Tomato | Fruit ripening altered | Line N73 | 3-Oct-1994 | | 94-227-01p_com |
| | | 01p | | | | 1436-111 | | | |
| B-81 | 94-090-01p | | Calgene | Rapeseed | Oil profile altered | pCGN3828- | | | 94-090-01p_com |
| | | | | | | 212/86-18 | | | |
| | | | | | | & 23 | | | |
| B-82 | 93-258-01p | | Monsanto | Soybean | Glyphosate tolerant | 40-3-2 | | | 93-258-01p_com |
| B-83 | 93-196-01p | | Calgene | Cotton | Bromoxynil tolerant | BXN | 22. Feb 94 | | 93-196-01p_com |
| B-84 | 92-204-01p | | Upjohn | Squash | WMV2 & ZYMV resistant | ZW-20 | 13-Dec-1994 | 92-204-01p_ea | 92-204-01p_com |
| B-85 | 92-196-01p | | Calgene | Tomato | Fruit ripening altered | FLAVR | 19-Oct-1992 | | 92-196-01p_com |
| | | | | | | SAVR | | | |

Particularly useful transgenic cereals, nuts, fruits and spices plants which may be treated according to the invention are plants listed in table B together with their trade names.

TABLE B

| No. | Trade Names | Example | Description |
|---|---|---|---|
| B-86 | Roundup Ready ® | Beta vulgaris (Sugar Beet) | H7-1 event |
| B-87 | InVigor ® | Brassica napus (Argentine Canola) | Canola has been genetically modified to: |
| | | | Ø express a gene conferring tolerance to the herbicide |
| | | | glufosinate ammonium; |
| | | | Ø introduce a novel hybrid breeding system for canola, |
| | | | based on genetically modified male sterile (MS) and |
| | | | fertility restorer (RF) lines; |
| | | | Ø express an antibiotic resistance gene. |
| B-88 | Liberty Link ® | Brassica napus (Argentine Canola) | tolerance to phosphinotricin |
| B-89 | Roundup Ready ® | Brassica napus (Canola) | MON89249-2 (GT200) event |
| B-90 | Clearfield ® | Canola | non-GMO, tolerance to imazamox |
| B-91 | Optimum ™ GAT ™ | Glycine max L. (Soybean) | tolerance to glyphosate and ALS herbicides |
| B-92 | Roundup Ready ® | Glycine max L. (Soybean) | MON-Ø4Ø32-6 (GTS 40-3-2) |
| B-93 | Roundup RReady2Yield ™ | Glycine max L. (Soybean) | MON-89788-1 (MON89788) event |
| B-94 | STS ® | Glycine max L. (Soybean) | tolerance to sulphonylureas |
| B-95 | YIELD GARD ® | Glycine max L. (Soybean) | |
| B-96 | AFD ® | Gossypium hirsutum L. (Cotton) | lines include eg AFD5062LL, AFD5064F, AFD 5065B2F, AFD seed |
| | | | is available in several varieties with technology incorporated, |
| | | | such as Bollgard ®, Bollgard II, Roundup Ready, Roundup |
| | | | Ready Flex and LibertyLink ® technologies. |
| B-97 | Bollgard II ® | Gossypium hirsutum L. (Cotton) | MON 15985 event: Cry2(A)b1; Cry1 A(c) |
| B-98 | Bollgard ® | Gossypium hirsutum L. (Cotton) | MON531/757/1076 event: Cry 1Ac |
| B-99 | FiberMax ® | Gossypium hirsutum L. (Cotton) | improved fiber quality |
| B-100 | Liberty Link ® | Gossypium hirsutum L. (Cotton) | tolerance to phosphinotricin |
| B-101 | Nucotn 33B | Gossypium hirsutum L. (Cotton) | Bt-toxin in Delta Pine lines: Cry1Ac |
| B-102 | Nucotn 35B | Gossypium hirsutum L. (Cotton) | Bt-toxin in Delta Pine lines: Cry1Ac |
| B-103 | Nucotn ® | Gossypium hirsutum L. (Cotton) | Bt-toxin in Delta Pine lines |
| B-104 | PhytoGen ™ | Gossypium hirsutum L. (Cotton) | covers varieties containing for example Roundup Ready flex, |
| | | | Widestrike, |
| B-105 | Roundup Ready Flex ® | Gossypium hirsutum L. (Cotton) | MON88913 event |
| B-106 | Roundup Ready ® | Gossypium hirsutum L. (Cotton) | MON1445/1698 event |
| B-107 | Widestrike ™ | Gossypium hirsutum L. (Cotton) | Cry1F and Cry1Ac |
| B-108 | YIELD GARD ® | Gossypium hirsutum L. (Cotton) | |
| B-109 | Roundup Ready ® | Medicago sativa (Alfalfa) | MON-ØØ1Ø1-8, MON-ØØ163-7 (J101, J163) event |
| B-110 | Clearfield ® | Oryza sativa (Rice) | non-GMO, tolerance to imazamox |
| B-111 | Atlantic and Superior New Leaf | Solanum tuberosum L. (Potato) | ATBT04-6, ATBT04-27, ATBT04-30, ATBT04-31, ATBT04-36, |
| | | | SPBT02-5, SPBT02-7 |
| B-112 | NewLeaf ® | Solanum tuberosum L. (Potato) | comprises e.g. the events: RBMT15-101, SEMT15-02, SEMT15-15 |
| B-113 | NewLeaf ® plus | Solanum tuberosum L. (Potato) | comprises e.g. the events: RBMT21-129, RBMT21-350, RBMT22-082 |
| B-114 | Protecta ® | Solanum tuberosum L. (Potato) | |
| B-115 | Russet Burbank NewLeaf ® | Solanum tuberosum L. (Potato) | comprises e.g. the events: BT6, BT10, BT12, BT16, BT17, |
| | | | BT18, BT23 |
| B-116 | Clearfield ® | Sunflower | non-GMO, tolerance to imazamox |
| B-117 | Roundup Ready ® | Triticum aestivum (Wheat) | MON71800 event |
| B-118 | Clearfield ® | Wheat | non-GMO, tolerance to imazamox |

Particularly useful transgenic plants which may be treated according to the invention are plants containing transformation events, or combination of transformation event that are listed for example in the databases from various national or regional regulatory agencies (see for example http://gmoinfojrc.it/gmpbrowse.aspx an http://www.agbios.com/dbase.php).

Further particularly genetically modified plants include plants containing a gene in an agronomically neutral or beneficial position as described by the event listed in Table C.

TABLE C

| No. | Event | Crop | Trait(s) which has been genetically modified |
|---|---|---|---|
| C-1 | ASR368 | Agrostis stolonifera Creeping Bentgrass | Glyphosate tolerance derived by inserting a modified 5-enolpyruvylshikimate-3-phosphate synthase (EPSPS) encoding |
| | | | gene from Agrobacterium tumefaciens. |
| C-2 | H7-1 | Beta vulgaris (Sugar Beet) | Glyphosate herbicide tolerant sugar beet produced by inserting a gene encoding the enzyme 5- |
| | | | enolypyruvylshikimate-3-phosphate synthase (EPSPS) from the CP4 strain of Agrobacterium tumefaciens. |
| C-3 | T120-7 | Beta vulgaris (Sugar Beet) | Introduction of the PPT-acetyltransferase (PAT) encoding gene from Streptomyces viridochromogenes, an |
| | | | aerobic soil bacteria. PPT normally acts to inhibit glutamine synthetase, causing a fatal accumulation of |
| | | | ammonia. Acetylated PPT is inactive. |
| C-4 | GTSB77 | Beta vulgaris (Sugar Beet) | Glyphosate herbicide tolerant sugar beet produced by inserting a gene encoding the enzyme 5- |
| | | | enolypyruvylshikimate-3-phosphate synthase (EPSPS) from the CP4 strain of Agrobacterium tumefaciens. |
| C-5 | 23-18-17, 23-198 | Brassica napus (Argentine Canola) | High laurate (12:0) and myristate (14:0) canola produced by inserting a thioesterase encoding gene from the |
| | | | California bay laurel (Umbellularia californica). |
| C-6 | 45A37, 46A40 | Brassica napus (Argentine Canola) | High oleic acid and low linolenic acid canola produced through a combination of chemical mutagenesis to select for a |
| | | | fatty acid desaturase mutant with elevated oleic acid, and traditional back-crossing to introduce the low |
| | | | linolenic acid trait. |
| C-7 | 46A12, 46A16 | Brassica napus (Argentine Canola) | Combination of chemical mutagenesis, to achieve the high oleic acid trait, and traditional breeding with |
| | | | registered canola varieties. |
| C-8 | GT200 | Brassica napus (Argentine Canola) | Glyphosate herbicide tolerant canola produced by inserting genes encoding the enzymes 5- |
| | | | enolypyruvylshikimate-3-phosphate synthase (EPSPS) from the CP4 strain of Agrobacterium tumefaciens and glyphosate |
| | | | oxidase from Ochrobactrum anthropi. |
| C-9 | GT73, RT73 | Brassica napus (Argentine Canola) | Glyphosate herbicide tolerant canola produced by inserting genes encoding the enzymes 5- |
| | | | enolypyruvylshikimate-3-phosphate synthase (EPSPS) from the CP4 strain of Agrobacterium tumefaciens and glyphosate |
| | | | oxidase from Ochrobactrum anthropi. |
| C-10 | HCN10 | Brassica napus (Argentine Canola) | Introduction of the PPT-acetyltransferase (PAT) encoding gene from Streptomyces viridochromogenes, an |
| | | | aerobic soil bacteria. PPT normally acts to inhibit glutamine synthetase, causing a fatal accumulation of |
| | | | ammonia. Acetylated PPT is inactive. |
| C-11 | Topas 19/2 (HCN92) | Brassica napus (Argentine Canola) | Introduction of the PPT-acetyltransferase (PAT) encoding gene from Streptomyces viridochromogenes, an |
| | | | aerobic soil bacteria. PPT normally acts to inhibit glutamine synthetase, causing a fatal accumulation of |
| | | | ammonia. Acetylated PPT is inactive. |
| C-12 | MS1, RF1 =>PGS1 | Brassica napus (Argentine Canola) | Male-sterility, fertility restoration, pollination control system displaying glufosinate herbicide tolerance. MS |
| | | | lines contained the barnase gene from Bacillus amyloliquefaciens, RF lines contained the barstar gene from the |
| | | | same bacteria, and both lines c |
| C-13 | MS1, RF2 =>PGS2 | Brassica napus (Argentine Canola) | Male-sterility, fertility restoration, pollination control system displaying glufosinate herbicide tolerance. MS |
| | | | lines contained the barnase gene from Bacillus amyloliquefaciens, RF lines contained the barstar gene from the |
| | | | same bacteria, and both lines c |
| C-14 | MS8 × RF3 | Brassica napus (Argentine Canola) | Male-sterility, fertility restoration, pollination control system displaying glufosinate herbicide tolerance. MS |
| | | | lines contained the barnase gene from Bacillus amyloliquefaciens, RF lines contained the barstar gene from the |
| | | | same bacteria, and both lines c |
| C-15 | NS738, NS1471, NS1473 | Brassica napus (Argentine Canola) | Selection of somaclonal variants with altered acetolactate synthase (ALS) enzymes, following chemical |
| | | | mutagenesis. Two lines (P1, P2) were initially selected with modifications at different unlinked loci. NS738 |
| | | | contains the P2 mutation only. |
| C-16 | OXY-235 | Brassica napus (Argentine Canola) | Tolerance to the herbicides bromoxynil and ioxynil by incorporation of the nitrilase gene (oxy) from Klebsiella |
| | | | pneumoniae. |
| C-17 | MS8 | Brassica napus (Argentine Canola) | Traits: Glufosinate tolerance, Male sterility Genes: bar, barnase |
| C-18 | PHY14, PHY35 | Brassica napus (Argentine Canola) | Male sterility was via insertion of the barnase ribonuclease gene from Bacillus amyloliquefaciens; fertility |
| | | | restoration by insertion of the barstar RNase inhibitor; PPT resistance was via PPT-acetyltransferase (PAT) from |
| | | | Streptomyces hygroscopicus. |
| C-19 | PHY36 | Brassica napus (Argentine Canola) | Male sterility was via insertion of the barnase ribonuclease gene from Bacillus amyloliquefaciens; fertility |
| | | | restoration by insertion of the barstar RNase inhibitor; PPT resistance was via PPT-acetyltransferase (PAT) from |
| | | | Streptomyces hygroscopicus. |
| C-20 | RF1, (B93-101) | Brassica napus (Argentine Canola) | Genes: bar, barstar, neomycin phosphotransferase II (npt II); Traits: Fertility restoration, Glufosinate |
| | | | tolerance, Kanamycin resistance |
| C-21 | RF2, (B94-101) | Brassica napus (Argentine Canola) | Genes: bar, barstar, neomycin phosphotransferase II (npt II); Traits: Fertility restoration, Glufosinate |
| | | | tolerance, Kanamycin resistance |
| C-22 | RF3, ACS-BNØØ3-6 | Brassica napus (Argentine Canola) | Traits: Fertility restoration, Glufosinate tolerance; Genes bar, barstar |
| C-23 | MS1 (B91-4) | Brassica napus (Argentine Canola) | Traits: Glufosinate tolerance, Kanamycin resistance, Male sterility; Genes: bar, barnase, neomycin |
| | | | phosphotransferase II (npt II) |
| C-24 | T45 (HCN28) | Brassica napus (Argentine Canola) | Introduction of the PPT-acetyltransferase (PAT) encoding gene from Streptomyces viridochromogenes, an |
| | | | aerobic soil bacteria. PPT normally acts to inhibit glutamine synthetase, causing a fatal accumulation of |
| | | | ammonia. Acetylated PPT is inactive. |
| C-25 | HCR-1 | Brassica rapa (Polish Canola) | Introduction of the glufosinate ammonium herbicide tolerance trait from transgenic B. napus line T45. This trait |
| | | | is mediated by the phosphinothricin acetyltransferase (PAT) encoding gene from S. viridochromogenes. |
| C-26 | ZSR500/502 | Brassica rapa (Polish Canola) | Introduction of a modified 5-enol-pyruvylshikimate-3-phosphate synthase (EPSPS) and a gene from |
| | | | Achromobacter sp that degrades glyphosate by conversion to aminomethylphosphonic acid (AMPA) and |
| | | | glyoxylate by interspecific crossing with GT73. |
| C-27 | 55-1/63-1 | Carica papaya (Papaya) | Papaya ringspot virus (PRSV) resistant papaya produced by inserting the coat protein (CP) encoding sequences from this |
| | | | plant potyvirus. |
| C-28 | RM3-3, RM3-4, RM3-6 | Cichorium intybus (Chicory) | Male sterility was via insertion of the barnase ribonuclease gene from Bacillus amyloliquefaciens; PPT |
| | | | resistance was via the bar gene from S. hygroscopicus, which encodes the PAT enzyme. |
| C-29 | A, B | Cucumis melo (Melon) | Reduced accumulation of S-adenosylmethionine (SAM), and consequently reduced ethylene synthesis, by |
| | | | introduction of the gene encoding S-adenosylmethionine hydrolase. |
| C-30 | CZW-3 | Cucurbita pepo (Squash) | Cucumber mosiac virus (CMV), zucchini yellows mosaic (ZYMV) and watermelon mosaic virus (WMV) 2 |
| | | | resistant squash (Curcurbita pepo) produced by inserting the coat protein (CP) encoding sequences from each of |
| | | | these plant viruses into the host genome. |
| C-31 | ZW20 | Cucurbita pepo (Squash) | Zucchini yellows mosaic (ZYMV) and watermelon mosaic virus (WMV) 2 resistant squash (Curcurbita pepo) |
| | | | produced by inserting the coat protein (CP) encoding sequences from each of these plant potyviruses into the |
| | | | host genome. |
| C-32 | 66 | Dianthus | Delayed senescence and sulfonylurea herbicide tolerant carnations produced by inserting a truncated copy of the |
| | | caryophyllus (Carnation) | carnation aminocyclopropane cyclase (ACC) synthase encoding gene in order to suppress expression of the |
| | | | endogenous unmodified gene, which is re |
| C-33 | 4, 11, 15, 16 | Dianthus | Modified colour and sulfonylurea herbicide tolerant carnations produced by inserting two anthocyanin |
| | | caryophyllus (Carnation) | biosynthetic genes whose expression results in a violet/mauve colouration. Tolerance to sulfonyl urea herbicides |
| | | | was via the introduction of a chlorsulfuro |
| C-34 | 11363 | Dianthus | Traits: Coloration; Genes als, dihydroflavonol reductase (dfr), flavonoid 3′,5′hydroxylase (F3′5′H) |
| | | caryophyllus (Carnation) | |
| C-35 | 959A, 988A, 1226A, 1351A, | Dianthus | Introduction of two anthocyanin biosynthetic genes to result in a violet/mauve colouration; Introduction of a |
| | 1363A, 1400A | caryophyllus (Carnation) | variant form of acetolactate synthase (ALS). |
| C-36 | 123.2. (40619) | Dianthus | Traits: Coloration; Genes als, dihydroflavonol reductase (dfr), flavonoid 3′,5′hydroxylase (F3′5′H) |
| | | caryophyllus (Carnation) | |
| C-37 | 123.8.8 (40685) | Dianthus | |
| | | caryophyllus (Carnation) | |
| C-38 | 11 (7442) | Dianthus | |
| | | caryophyllus (Carnation) | |
| C-39 | A2704-12, A2704-21, A5547- | Glycine max L. (Soybean) | Glufosinate ammonium herbicide tolerant soybean produced by inserting a modified phosphinothricin |
| | 35 | | acetyltransferase (PAT) encoding gene from the soil bacterium Streptomyces viridochromogenes. |
| C-40 | A5547-127 | Glycine max L. (Soybean) | Glufosinate ammonium herbicide tolerant soybean produced by inserting a modified phosphinothricin |
| | | | acetyltransferase (PAT) encoding gene from the soil bacterium Streptomyces viridochromogenes. |
| C-41 | G94-1, G94-19, G168 | Glycine max L. (Soybean) | High oleic acid soybean produced by inserting a second copy of the fatty acid desaturase (GmFad2-1) encoding |
| | | | gene from soybean, which resulted in “silencing” of the endogenous host gene. |
| C-42 | GTS 40-3-2 | Glycine max L. (Soybean) | Glyphosate tolerant soybean variety produced by inserting a modified 5-enolpyruvylshikimate-3-phosphate |
| | | | synthase (EPSPS) encoding gene from the soil bacterium Agrobacterium tumefaciens. |
| C-43 | GU262 | Glycine max L. (Soybean) | Glufosinate ammonium herbicide tolerant soybean produced by inserting a modified phosphinothricin |
| | | | acetyltransferase (PAT) encoding gene from the soil bacterium Streptomyces viridochromogenes. |
| C-44 | MON89788 | Glycine max L. (Soybean) | Glyphosate-tolerant soybean produced by inserting a modified 5-enolpyruvylshikimate-3-phosphate synthase |
| | | | (EPSPS) encoding aroA (epsps) gene from Agrobacterium tumefaciens CP4. |
| C-45 | OT96-15 | Glycine max L. (Soybean) | Low linolenic acid soybean produced through traditional cross-breeding to incorporate the novel trait from a |
| | | | naturally occurring fan1 gene mutant that was selected for low linolenic acid. |
| C-46 | W62, W98 | Glycine max L. (Soybean) | Glufosinate ammonium herbicide tolerant soybean produced by inserting a modified phosphinothricin |
| | | | acetyltransferase (PAT) encoding gene from the soil bacterium Streptomyces hygroscopicus. |
| C-47 | 15985 | Gossypium hirsutum L. (Cotton) | Insect resistant cotton derived by transformation of the DP50B parent variety, which contained event 531 |
| | | | (expressing Cry1Ac protein), with purified plasmid DNA containing the cry2Ab gene from B. thuringiensis |
| | | | subsp. kurstaki. |
| C-48 | 19-51A | Gossypium hirsutum L. (Cotton) | Introduction of a variant form of acetolactate synthase (ALS). |
| C-49 | 281-24-236 | Gossypium hirsutum L. (Cotton) | Insect-resistant cotton produced by inserting the cry1F gene from Bacillus thuringiensisvar. aizawai. The PAT |
| | | | encoding gene from Streptomyces viridochromogenes was introduced as a selectable marker. |
| C-50 | 3006-210-23 | Gossypium hirsutum L. (Cotton) | Insect-resistant cotton produced by inserting the cry1Ac gene from Bacillus thuringiensis subsp. kurstaki. The |
| | | | PAT encoding gene from Streptomyces viridochromogenes was introduced as a selectable marker. |
| C-51 | 31807/31808 | Gossypium hirsutum L. (Cotton) | Insect-resistant and bromoxynil herbicide tolerant cotton produced by inserting the cry1Ac gene from Bacillus |
| | | | thuringiensis and a nitrilase encoding gene from Klebsiella pneumoniae. |
| C-52 | BXN | Gossypium hirsutum L. (Cotton) | Bromoxynil herbicide tolerant cotton produced by inserting a nitrilase encoding gene from Klebsiella |
| | | | pneumoniae. |
| C-53 | COT102 | Gossypium hirsutum L. (Cotton) | Insect-resistant cotton produced by inserting the vip3A(a) gene from Bacillus thuringiensis AB88. The APH4 |
| | | | encoding gene from E. coli was introduced as a selectable marker. |
| C-54 | DAS-21Ø23-5 × DAS-24236-5 | Gossypium hirsutum L. (Cotton) | WideStrike ™, a stacked insect-resistant cotton derived from conventional cross-breeding of parental lines 3006- |
| | | | 210-23 (OECD identifier: DAS-21Ø23-5) and 281-24-236 (OECD identifier: DAS-24236-5). |
| C-55 | DAS-21Ø23-5 × DAS-24236- | Gossypium hirsutum L. (Cotton) | Stacked insect-resistant and glyphosate-tolerant cotton derived from conventional cross-breeding of WideStrike |
| | 5 × MON88913 | | cotton (OECD identifier: DAS-21Ø23-5 × DAS-24236-5) with MON88913, known as RoundupReady Flex |
| | | | (OECD identifier: MON-88913-8). |
| C-56 | DAS-21Ø23-5 × DAS-24236- | Gossypium hirsutum L. (Cotton) | WideStrike ™/Roundup Ready ® cotton, a stacked insect-resistant and glyphosate-tolerant cotton derived from |
| | 5 × MON-Ø1445-2 | | conventional cross-breeding of WideStrike cotton (OECD identifier: DAS-21Ø23-5 × DAS-24236-5) with |
| | | | MON1445 (OECD identifier: MON-Ø1445-2). |
| C-57 | LLCotton25 | Gossypium hirsutum L. (Cotton) | Glufosinate ammonium herbicide tolerant cotton produced by inserting a modified phosphinothricin |
| | | | acetyltransferase (PAT) encoding gene from the soil bacterium Streptomyces hygroscopicus. |
| C-58 | LLCotton25 × MON15985 | Gossypium hirsutum L. (Cotton) | Stacked herbicide tolerant and insect resistant cotton combining tolerance to glufosinate ammonium herbicide |
| | | | from LLCotton25 (OECD identifier: ACS-GHØØ1-3) with resistance to insects from MON15985 (OECD |
| | | | identifier: MON-15985-7) |
| C-59 | MON1445/1698 | Gossypium hirsutum L. (Cotton) | Glyphosate herbicide tolerant cotton produced by inserting a naturally glyphosate tolerant form of the enzyme 5- |
| | | | enolpyruvyl shikimate-3-phosphate synthase (EPSPS) from A. tumefaciens strain CP4. |
| C-60 | MON15985 × MON88913 | Gossypium hirsutum L. (Cotton) | Stacked insect resistant and glyphosate tolerant cotton produced by conventional cross-breeding of the parental |
| | | | lines MON88913 (OECD identifier: MON-88913-8) and 15985 (OECD identifier: MON-15985-7). Glyphosate |
| | | | tolerance is derived from MON88913 which con |
| C-61 | MON-15985-7 × MON- | Gossypium hirsutum L. (Cotton) | Stacked insect resistant and herbicide tolerant cotton derived from conventional cross-breeding of the parental |
| | Ø1445-2 | | lines 15985 (OECD identifier: MON-15985-7) and MON1445 (OECD identifier: MON-Ø1445-2). |
| C-62 | MON531/757/1076 | Gossypium hirsutum L. (Cotton) | Insect-resistant cotton produced by inserting the cry1Ac gene from Bacillus thuringiensis subsp. kurstaki HD-73 |
| | | | (B.t.k.). |
| C-63 | MON88913 | Gossypium hirsutum L. (Cotton) | Glyphosate herbicide tolerant cotton produced by inserting two genes encoding the enzyme 5- |
| | | | enolypyruvylshikimate-3-phosphate synthase (EPSPS) from the CP4 strain of Agrobacterium tumefaciens. |
| C-64 | MON-ØØ531-6 × MON- | Gossypium hirsutum L. (Cotton) | Stacked insect resistant and herbicide tolerant cotton derived from conventional cross-breeding of the parental |
| | Ø1445-2 | | lines MON531 (OECD identifier: MON-ØØ531-6) and MON1445 (OECD identifier: MON-Ø1445-2). |
| C-65 | T304-40 | Gossypium hirsutum L. (Cotton) | Genetic elements which confer the phenotype insect resistant and glufosinate ammonium herbicide tolerance: |
| | | | cry1: Coding sequence of cry gene from Bacillus thuringiensis that confers the insect resistance trait. |
| | | | bar: Coding sequence of the phosphinoth |
| C-66 | GHB714 | Gossypium hirsutum L. (Cotton) | Genetic elements which confer the phenotype insect resistant and glufosinate ammonium herbicide tolerance: |
| | | | cry2: Coding sequence of cry gene from Bacillus thuringiensis that confers the insect resistance trait. |
| | | | bar: Coding sequence of the phosphinoth |
| C-67 | GHB119 | Gossypium hirsutum L. (Cotton) | Genetic elements which confer the phenotype insect resistant and glufosinate ammonium herbicide tolerance: |
| | | | cry2: Coding sequence of cry gene from Bacillus thuringiensis that confers the insect resistance trait. |
| | | | bar: Coding sequence of the phosphinoth |
| C-68 | T303-3 | Gossypium hirsutum L. (Cotton) | cry1: Coding sequence of cry gene from Bacillus thuringiensis that confers the insect resistance trait. |
| | | | bar: Coding sequence of the phosphinothricin acetyltransferase gene (bar) from Streptomyces hygroscopicus |
| | | | that confers the herbicide resistance trai |
| C-69 | GHB614 | Gossypium hirsutum L. (Cotton) | 2mepsps: Coding sequence of 2mepsps from maize that confers the glyphosate herbicide resistance trait. |
| C-70 | X81359 | Helianthus annuus (Sunflower) | Tolerance to imidazolinone herbicides by selection of a naturally occurring mutant. |
| C-71 | RH44 | Lens culinaris (Lentil) | Selection for a mutagenized version of the enzyme acetohydroxyacid synthase (AHAS), also known as |
| | | | acetolactate synthase (ALS) or acetolactate pyruvate-lyase. |
| C-72 | FP967 | Linum usitatissimum L. (Flax, | A variant form of acetolactate synthase (ALS) was obtained from a chlorsulfuron tolerant line of A. thaliana and |
| | | Linseed) | used to transform flax. |
| C-73 | 5345 | Lycopersicon | Resistance to lepidopteran pests through the introduction of the cry1Ac gene from Bacillus thuringiensis subsp. |
| | | esculentum (Tomato) | Kurstaki. |
| C-74 | 8338 | Lycopersicon | Introduction of a gene sequence encoding the enzyme 1-amino-cyclopropane-1-carboxylic acid deaminase |
| | | esculentum (Tomato) | (ACCd) that metabolizes the precursor of the fruit ripening hormone ethylene. |
| C-75 | 1345-4 | Lycopersicon | Delayed ripening tomatoes produced by inserting an additional copy of a truncated gene encoding 1- |
| | | esculentum (Tomato) | aminocyclopropane-1-carboxyllic acid (ACC) synthase, which resulted in downregulation of the endogenous |
| | | | ACC synthase and reduced ethylene accumulation. |
| C-76 | 35 1N | Lycopersicon | Introduction of a gene sequence encoding the enzyme S-adenosylmethionine hydrolase that metabolizes the |
| | | esculentum (Tomato) | precursor of the fruit ripening hormone ethylene |
| C-77 | B, Da, F | Lycopersicon | Delayed softening tomatoes produced by inserting a truncated version of the polygalacturonase (PG) encoding |
| | | esculentum (Tomato) | gene in the sense or anti-sense orientation in order to reduce expression of the endogenous PG gene, and thus |
| | | | reduce pectin degradation. |
| C-78 | FLAVR SAVR | Lycopersicon | Delayed softening tomatoes produced by inserting an additional copy of the polygalacturonase (PG) encoding |
| | | esculentum (Tomato) | gene in the anti-sense orientation in order to reduce expression of the endogenous PG gene and thus reduce |
| | | | pectin degradation. |
| C-79 | J101, J163 | Medicago sativa (Alfalfa) | Glyphosate herbicide tolerant alfalfa (lucerne) produced by inserting a gene encoding the enzyme 5- |
| | | | enolypyruvylshikimate-3-phosphate synthase (EPSPS) from the CP4 strain of Agrobacterium tumefaciens. |
| C-80 | C/F/93/08-02 | Nicotiana tabacum L. (Tobacco) | Tolerance to the herbicides bromoxynil and ioxynil by incorporation of the nitrilase gene from Klebsiella |
| | | | pneumoniae. |
| C-81 | Vector 21-41 | Nicotiana tabacum L. (Tobacco) | Reduced nicotine content through introduction of a second copy of the tobacco quinolinic acid |
| | | | phosphoribosyltransferase (QTPase) in the antisense orientation. The NPTII encoding gene from E. coli was |
| | | | introduced as a selectable marker to identify transform |
| C-82 | CL121, CL141, CFX51 | Oryza sativa (Rice) | Tolerance to the imidazolinone herbicide, imazethapyr, induced by chemical mutagenesis of the acetolactate |
| | | | synthase (ALS) enzyme using ethyl methanesulfonate (EMS). |
| C-83 | IMINTA-1, IMINTA-4 | Oryza sativa (Rice) | Tolerance to imidazolinone herbicides induced by chemical mutagenesis of the acetolactate synthase (ALS) |
| | | | enzyme using sodium azide. |
| C-84 | LLRICE06, LLRICE62 | Oryza sativa (Rice) | Glufosinate ammonium herbicide tolerant rice produced by inserting a modified phosphinothricin |
| | | | acetyltransferase (PAT) encoding gene from the soil bacterium Streptomyces hygroscopicus). |
| C-85 | LLRICE601 | Oryza sativa (Rice) | Glufosinate ammonium herbicide tolerant rice produced by inserting a modified phosphinothricin |
| | | | acetyltransferase (PAT) encoding gene from the soil bacterium Streptomyces hygroscopicus). |
| C-86 | PWC16 | Oryza sativa (Rice) | Tolerance to the imidazolinone herbicide, imazethapyr, induced by chemical mutagenesis of the acetolactate |
| | | | synthase (ALS) enzyme using ethyl methanesulfonate (EMS). |
| C-87 | ATBT04-6, ATBT04-27, | Solanum tuberosum L. (Potato) | Colorado potato beetle resistant potatoes produced by inserting the cry3A gene from Bacillus thuringiensis |
| | ATBT04-30, ATBT04-31, | | (subsp. Tenebrionis). |
| | ATBT04-36, SPBT02-5, | | |
| | SPBT02-7 | | |
| C-88 | BT6, BT10, BT12, BT16, | Solanum tuberosum L. (Potato) | Colorado potato beetle resistant potatoes produced by inserting the cry3A gene from Bacillus thuringiensis |
| | BT17, BT18, BT23 | | (subsp. Tenebrionis). |
| C-89 | RBMT15-101, SEMT15-02, | Solanum tuberosum L. (Potato) | Colorado potato beetle and potato virus Y (PVY) resistant potatoes produced by inserting the cry3A gene from |
| | SEMT15-15 | | Bacillus thuringiensis (subsp. Tenebrionis) and the coat protein encoding gene from PVY. |
| C-90 | RBMT21-129, RBMT21-350, | Solanum tuberosum L. (Potato) | Colorado potato beetle and potato leafroll virus (PLRV) resistant potatoes produced by inserting the cry3A gene |
| | RBMT22-082 | | from Bacillus thuringiensis (subsp. Tenebrionis) and the replicase encoding gene from PLRV. |
| C-91 | AM02-1003, AM01-1005, | Solanum tuberosum L. (Potato) | a) A gene containing the coding region of potato gbss in antisense orientation relative to the promoter, flanked |
| | AM02-1012, AM02-1017, | | by the gbss promoter from Solanum tuberosum and the polyadenylation sequence from Agrobacterium |
| | AM99-1089 and AM99-2003 | | tumefaciens nopaline synthase gene has been in |
| C-92 | EH92-527-1 | Solanum tuberosum L. (Potato) | In potato event EH92-527-1 a gene consisting of a potato gbss (granule bound starch synthase) promoter, a |
| | | | fragment of the coding region of potato gbss in antisense orientation relative to the promoter and the |
| | | | polyadenylation sequence from Agrobacterium tu |
| C-93 | AP205CL | Triticum aestivum (Wheat) | Selection for a mutagenized version of the enzyme acetohydroxyacid synthase (AHAS), also known as |
| | | | acetolactate synthase (ALS) or acetolactate pyruvate-lyase. |
| C-94 | AP602CL | Triticum aestivum (Wheat) | Selection for a mutagenized version of the enzyme acetohydroxyacid synthase (AHAS), also known as |
| | | | acetolactate synthase (ALS) or acetolactate pyruvate-lyase. |
| C-95 | BW255-2, BW238-3 | Triticum aestivum (Wheat) | Selection for a mutagenized version of the enzyme acetohydroxyacid synthase (AHAS), also known as |
| | | | acetolactate synthase (ALS) or acetolactate pyruvate-lyase. |
| C-96 | MON71800 | Triticum aestivum (Wheat) | Glyphosate tolerant wheat variety produced by inserting a modified 5-enolpyruvylshikimate-3-phosphate |
| | | | synthase (EPSPS) encoding gene from the soil bacterium Agrobacterium tumefaciens, strain CP4. |
| C-97 | SWP965001 | Triticum aestivum (Wheat) | Selection for a mutagenized version of the enzyme acetohydroxyacid synthase (AHAS), also known as |
| | | | acetolactate synthase (ALS) or acetolactate pyruvate-lyase. |
| C-98 | DW2, DW6, DW12 | Triticum aestivum (Wheat) | |
| C-99 | BW7 | Triticum aestivum (Wheat) | Tolerance to imidazolinone herbicides |
| C-100 | Teal 11A | Triticum aestivum (Wheat) | Selection for a mutagenized version of the enzyme acetohydroxyacid synthase (AHAS), also known as |
| | | | acetolactate synthase (ALS) or acetolactate pyruvate-lyase. |
| C-149 | DP 444 BG/RR | Gossypium hirsutum L. (Cotton) | Bollgard/RoundupReady, from US 2003213029-A1 |

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Ipconazole and Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Propiconazole and Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole and Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Ipconazole and Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Propiconazole and Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole and Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Ipconazole and Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Propiconazole and Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole and Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Ipconazole and Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Propiconazole and Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole and Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Fludioxonil and Myclobutanil. on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Ipconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Propiconazole and Ipconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole and Ipconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Ipconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Ipconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Propiconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole and Propiconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Propiconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Propiconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Prothioconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole and Prothioconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Prothioconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Metconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole and Metconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole and Tebuconazole. on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Cyproconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Epoxiconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Flusilazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Ipconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Propiconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prothioconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Metconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Tebuconazole on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Triadimenol on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Azoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Fluoxastrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Kresoxim-methyl on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Picoxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Pyraclostrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Trifloxystrobin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Boscalid on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Chlorothalonil on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Cyprodinil on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Fludioxonil on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Fluopyram on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Myclobutonil on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Prochloraz on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of Spiroxamine on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of N-(3′4′-dichloro-5-fluoro[11′-biphenyl]-2-yl)-3-(difluoromethyl)-1-methyl-1H-pyrazole-4-carboxamide on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of 5-Chlor-6-(246-trifluorphenyl)-7-(4-methylpiperidin-1-yl)[124]triazolo[15 a]pyrimidin on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of 1-methyl-N-{2-[1′-methyl-11′-bi(cyclopropyl)-2-yl]phenyl}-3-(trifluoromethyl)-1H-pyrazole-4-carboxamide on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of N-{2-[11′-bi(cyclopropyl)-2-yl]phenyl}-1-methyl-3-(trifluoromethyl)-1H-pyrazole-4-carboxamide on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of 1-methyl-N-{2-[1′-methyl-11′-bi(cyclopropyl)-2-yl]phenyl}-3-(difluoromethyl)-1H-pyrazole-4-carboxamide on genetically modified peanuts and cotton wherein the active principle expressed by the genetically modified plant corresponds to a line of table A, B, or C.

In a very particular embodiment a method of reducing the contamination with aflatoxin B1, B2, G1 and G2 of peanut, cashew, cocoa, raisin, grape, soybean, manioc, cotton plants and/or plant material from peanuts, cashews, cocoa, raisins, grapes, soybeans, manioc, cotton before or after harvest or during storage is described which comprises the use of N-{2-[11′-bi(cyclopropyl)-2-yl]phenyl}-1-methyl-3-(difluoromethyl)-1H-pyrazole-4-carboxamide on genetically modified peanuts and cotton wherein the active principle expressed by the genetically modified plant corresponds to a line of table A, B, or C.

In a further aspect there is provided a composition comprising one or a combination of two or more fungicidal compounds selected from the group (I) according to this invention. Preferably the fungicidal composition comprises agriculturally acceptable additives, solvents, carriers, surfactants, or extenders.

According to the invention, the term “carrier” denotes a natural or synthetic, organic or inorganic compound with which one or a combination of two or more fungicidal compounds selected from the group (I) are combined or associated to make it easier to apply, notably to the parts of the plant. This support is thus preferably inert and should be at least agriculturally acceptable. The support may be a solid or a liquid.

Suitable solid carriers are the following:

e.g. ammonium salts and natural rock powders, such as kaolins, clays, talcum, chalk, quartz, attapulgite, montmorillonite or diatomaceous earth and synthetic rock powders such as highly disperse silica, aluminium oxide and silicates, oil waxes, solid fertilizers, water, alcohols, preferably butanol, organic solvents, mineral and vegetable oils and derivatives thereof;
suitable solid carriers for granules are: for example crushed and fractionated natural rocks such as calcite, marble, pumice, sepiolite, dolomite and synthetic granules of inorganic and organic powders and granules of organic materials such as paper, sawdust, coconut shells, corn stalks and tobacco stalks;

By liquefied gaseous diluents or supports are meant such liquids that are gaseous at normal temperature and under normal pressure, for example, aerosol propellants such as halohydrocarbons as well as butane, propane, nitrogen and carbon dioxide.

It is possible to use in the formulations adhesives such as carboxymethylcellulose, natural and synthetic powdered, granular or latex-like polymers such as gum arabic, polyvinyl alcohol, polyvinyl acetate and natural phospholipids, such as cephalins and lecithins and synthetic phospholipids. Further additives can be mineral or vegetable oils and waxes, optionally modified.

Suitable extenders are, for example, water, polar and non-polar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkyl-naphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

The composition according to the invention may also comprise additional components. In particular, the composition may further comprise a surfactant. The surfactant can be an emulsifier, a dispersing agent or a wetting agent of ionic or non-ionic type or a mixture of such surfactants. Mention may be made, for example, of polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (in particular alkylphenols or arylphenols), salts of sulphosuccinic acid esters, taurine derivatives (in particular alkyl taurates), phosphoric esters of polyoxyethylated alcohols or phenols, fatty acid esters of polyols, and derivatives of the present compounds containing sulphate, sulphonate and phosphate functions, for example alkylaryl polyglycol ethers, alkyl sulphonates, alkyl sulphates, aryl sulphonates, protein hydrolyzates, lignosulphite waste liquors and methyl cellulose. The presence of at least one surfactant is generally essential when the active compound and/or the inert support are water-insoluble and when the vector agent for the application is water. Preferably, surfactant content may be comprised from 5% to 40% by weight of the composition.

Suitable emulsifiers and/or foam-forming agents are: for example non-ionic and anionic emulsifiers, such as polyoxyethylene fatty acid esters, polyoxyethylene fatty alcohol ethers, suitable dispersants are non-ionic and/or ionic substances, for example from the classes comprising alcohol POE and/or POP ethers, acid and/or POP or POE esters, alkyl-aryl and/or POP or POE ethers, fatty and/or POP-POE adducts, POE and/or POP polyol derivatives, POE and/or POP/sorbitan or sugar adducts, alkyl or aryl sulphates, sulphonates and phosphates or the corresponding PO ether adducts. Furthermore, suitable oligomers or polymers, for example based on vinyl monomers, acrylic acid, EO and/or PO alone or in combination with for example (poly-) alcohols or (poly-amines. Use can also be made of lignin and sulphonic acid derivatives thereof, simple and modified celluloses, aromatic and/or aliphatic sulphonic acids and adducts thereof with formaldehyde. Suitable as dispersants are for example lignosulphite waste liquors and methylcellulose.

Colouring agents such as inorganic pigments, for example iron oxide, titanium oxide, ferrocyanblue, and organic pigments such as alizarin, azo and metallophthalocyanine dyes, and trace elements such as iron, manganese, boron, copper, cobalt, molybdenum and zinc salts can be used.

Optionally, other additional components may also be included, e.g. protective colloids, adhesives, thickeners, thixotropic agents, penetration agents, stabilisers, sequestering agents. More generally, the active compounds can be combined with any solid or liquid additive, which complies with the usual formulation techniques.

In general, the composition according to the invention may contain from 0.05 to 99% by weight of active compounds, preferably from 1 to 70% by weight, most preferably from 10 to 50% by weight.

The combination or composition according to the invention can be used as such, in form of their formulations or as the use forms prepared therefrom, such as aerosol dispenser, capsule suspension, cold fogging concentrate, hot fogging concentrate, encapsulated granule, fine granule, flowable concentrate for seed treatment, ready-to-use solutions, dustable powder, emulsifiable concentrate, emulsion oil in water, emulsion water in oil, macrogranule, microgranule, oil dispersible powder, oil miscible flowable concentrate, oil miscible liquid, froths, paste, seed coated with a pesticide, suspension concentrate (flowable concentrate), suspensions-emulsions-concentrates, soluble concentrate, suspensions, soluble powder, granule, water soluble granules or tablets, water soluble powder for seed treatment, wettable powder, natural and synthetic materials impregnated with active compound, micro-encapsulation in polymeric materials and in jackets for seed, as well as ULV-cold and hot fogging formulations, gas (under pressure), gas generating product, plant rodlet, powder for dry seed treatment, solution for seed treatment, ultra low volume (ULV) liquid, ultra low volume (ULV) suspension, water dispersible granules or tablets, water dispersible powder for slurry treatment.

These formulations are prepared in a known manner by mixing the active compounds or active compound combinations with customary additives, such as, for example, customary extenders and also solvents or diluents, emulsifiers, dispersants, and/or bonding or fixing agent, wetting agents, water repellents, if appropriate siccatives and UV stabilisers, colorants, pigments, defoamers, preservatives, secondary thickeners, adhesives, gibberellins and water as well further processing auxiliaries.

These compositions include not only compositions which are ready to be applied to the plant or seed to be treated by means of a suitable device, such as a spraying or dusting device, but also concentrated commercial compositions which must be diluted before application to the crop.

The reduction in afla- and ochratoxin contamination is carried out primarily by treating the soil and the above-ground parts of plants with crop protection agents. Owing to the concerns regarding a possible impact of crop protection agents on the environment and the health of humans and animals, there are efforts to reduce the amount of active compounds applied.

The active compound and active compound combinations according to the invention can be used in its commercially available formulations and in the use forms, prepared from these formulations, as a mixture with other active compounds, such as attractants, sterilizing agents, bactericides, nematicides, fungicides, growth-regulating substances, herbicides, safeners, fertilizers or semiochemicals.

The treatment of plants and plant parts with one or a combination of two or more fungicidal compounds selected from the group (I) according to the invention is carried out directly or by action on their environment, habitat or storage area by means of the normal treatment methods, for example by watering (drenching), drip irrigation, spraying, vaporizing, atomizing, broadcasting, dusting, foaming, spreading-on, and as a powder for dry seed treatment, a solution for seed treatment, a water-soluble powder for seed treatment, a water-soluble powder for slurry treatment, or by encrusting, in the case of plant material, in particular in the case of seeds, furthermore by dry treatments, slurry treatments, liquid treatments, by one- or multi-layer coating. It is furthermore possible to apply the active compounds by the ultra-low volume method, or to inject the active compound preparation or the active compound itself into the soil.

The method of treatment according to the invention also provides the use of one or a combination of two or more fungicidal compounds selected from the group (I) in a simultaneous, separate or sequential manner.

The dose of active compound/application rate usually applied in the method of treatment according to the invention is generally and advantageously
for foliar treatments: from 0.1 to 10,000 g/ha, preferably from 10 to 1,000 g/ha, more preferably from 50 to 300 g/ha; in case of drench or drip application, the dose can even be reduced, especially while using inert substrates like rockwool or perlite;
for seed treatment: from 2 to 200 g per 100 kilogram of seed, preferably from 3 to 150 g per 100 kilogram of seed;
for soil treatment: from 0.1 to 10,000 g/ha, preferably from 1 to 5,000 g/ha.

The doses herein indicated are given as illustrative examples of the method according to the invention. A person skilled in the art will know how to adapt the application doses, notably according to the nature of the plant or crop to be treated.

The method of treatment according to the invention may also be useful to treat plant material such as seeds, seedlings or seedlings pricking out and plants or plants pricking out. This method of treatment can also be useful to treat roots. The method of treatment according to the invention can also be useful to treat the over-ground parts of the plant such as stems, ears, tassels, silks, cobs and kernels of the concerned plant.

The invention comprises a procedure in which the transgenic seed is treated at the same time with one or a combination of two or more fungicidal compounds selected from the group (I). It further comprises a method in which the transgenic seed is treated with one or a combination of two or more fungicidal compounds selected from the group (I) separately.

The invention also comprises a transgenic seed, which has been treated with one or a combination of two or more fungicidal compounds selected from the group (I) at the same time. The invention also comprises a transgenic seed, which has been treated with one or a combination of two or more fungicidal compounds selected from the group (I) separately. For the latter transgenic seed, the active ingredients can be applied in separate layers. These layers can optionally be separated by an additional layer that may or may not contain an active ingredient.

The compound or a combination of two or more fungicidal compounds selected from the group (I) and/or compositions of the invention are particularly suitable for the treatment of transgenic seeds. A large part of the damage caused by pests and/or phytopathogenic fungi on cultigens occurs by infestation of the transgenic seed during storage and after sowing the transgenic seed in the ground as well as during and after germination of the plants. This phase is especially critical since the roots and shoots of the growing plant are particularly sensitive and even a small amount of damage can lead to withering of the whole plant. There is therefore considerable interest in protecting the transgenic seed and the germinating plant by the use of suitable agents.

The control of pests and/or phytopathogenic fungi by treatment of the transgenic seeds of plants has been known for a considerable time and is the object of continuous improvement. However, there are a number of problems in the treatment of transgenic seed that cannot always be satisfactorily solved. Therefore it is worthwhile to develop methods for the protection of transgenic seeds and germinating plants which makes the additional application of plant protection agents after seeding or after germination of the plants unnecessary. It is further worthwhile to optimize the amount of the applied active material such that the transgenic seed and the germinating plants are protected against infestation by pests and/or phytopathogenic fungi as best as possible without the plants themselves being damaged by the active compound applied. In particular, methods for the treatment transgenic seed should also take into account the intrinsic fungicidal and insecticidal properties of transgenic plants in order to achieve optimal protection of the transgenic seed and germinating plants with a minimal expenditure of plant protection agents.

The present invention relates therefore especially to a method for the protection of transgenic seed and germinating plants from infestation with pests and/or phytopathogenic fungi and/or microorganisms in that the transgenic seed is treated with the combination/composition of the invention. In addition the invention relates also to the use of the combination/composition of the invention for the treatment of transgenic seed for protection of the transgenic seed and the germinating plants from pests and/or phytopathogenic fungi and/or microorganisms. Furthermore the invention relates to transgenic seed which was treated with a combination/composition of the invention for protection from pests and/or phytopathogenic fungi and/or microorganisms.

One of the advantages of the invention is because of the special systemic properties of the combination/composition of the invention treatment with one or a combination of two or more fungicidal compounds selected from the group (I) protect not only the transgenic seed itself but also the plants emerging after sprouting. In this way the direct treatment of the culture at the time of sowing or shortly thereafter can be omitted.

A further advantage is the synergistic increase in fungicidal activity of the combination/composition of the invention in comparison to the respective individual active compounds, which extends beyond the sum of the activity of both individually, applied active compounds. In this way an optimization of the amount of active compound applied is made possible.

It is also be regarded as advantageous that the mixtures of the invention can also be used in particular with such transgenic seeds whereby the plants emerging from this seed are capable of the expression of a protein directed against pests and phytopathogenic fungi and/or microorganisms. By treatment of such seed with the agents of the invention certain pests and/or phytopathogenic fungi and/or microorganisms can already be controlled by expression of the, for example, insecticidal protein, and it is additionally surprising that a synergistic activity supplementation occurs with the agents of the invention, which improves still further the effectiveness of the protection from pest infestation.

As already described, the treatment of transgenic seed with a one or a combination of two or more fungicidal compounds selected from the group (I) of the invention is of particular importance. This concerns the seeds of plants which generally contain at least one heterologous gene that controls the expression of a polypeptide with special insecticidal properties. The heterologous gene in transgenic seed can originate from microorganisms such as Bacillus, Rhizobium, Pseudomonas, Serratia, Trichoderma, Clavibacter, Glomus or Gliocladium. The present invention is particularly suitable for the treatment of transgenic seed that contains at least one heterologous gene that originates from Bacillus sp. and whose gene product exhibits activity against the European corn borer and/or western corn rootworm. Particularly preferred is a heterologous gene that originates from Bacillus thuringiensis.

Within the context of the present invention one or a combination of two or more fungicidal compounds selected from the group (I) of the invention is applied to the transgenic seed alone or in a suitable formulation. Preferably the transgenic seed is handled in a state in which it is so stable, that no damage occurs during treatment. In general treatment of the transgenic seed can be carried out at any time between harvest and sowing. Normally transgenic seed is used that was separated from the plant and has been freed of spadix, husks, stalks, pods, wool or fruit flesh. Use of transgenic seed that was harvested, purified, and dried to moisture content of below 15% w/w. Alternatively, transgenic seed treated with water after drying and then dried again can also be used.

In general care must be taken during the treatment of the transgenic seed that the amount of one or a combination of two or more fungicidal compounds selected from the group (I) of the invention and/or further additive applied to the transgenic seed is so chosen that the germination of the transgenic seed is not impaired and the emerging plant is not damaged. This is to be noted above all with active compounds which can show phytotoxic effects when applied in certain amounts.

One or a combination of two or more fungicidal compounds selected from the group (I) of the invention can be applied directly, that is without containing additional components and without being diluted. It is normally preferred to apply the combination/composition to the transgenic seed in the form of a suitable formulation. Suitable formulations and methods for transgenic seed treatment are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

One compound or a combination of two or more fungicidal compounds selected from the group (I) and compositions which can be used according to the invention can be converted into customary seed dressing formulations, such as solutions, emulsions, suspensions, powders, foams, slurries or other coating materials for seed, and also ULV formulations.

These formulations are prepared in a known manner by mixing the active compounds or active compound combinations with customary additives, such as, for example, customary extenders and also solvents or diluents, colorants, wetting agents, dispersants, emulsifiers, defoamers, preservatives, secondary thickeners, adhesives, gibberellins and optionally water as well.

Suitable colorants that may be present in the seed dressing formulations of the invention include all colorants customary for such purposes. Use may be made both of pigments, of sparing solubility in water, and of dyes, which are soluble in water. Examples that may be mentioned include the colorants known under the designations rhodamine B, C.I. Pigment Red 112, and C.I. Solvent Red 1.

Suitable wetting agents that may be present in the seed dressing formulations of the invention include all substances which promote wetting and are customary in the formulation of active agrochemical substances. With preference it is possible to use alkylnaphthalene-sulphonates, such as diisopropyl- or diisobutylnaphthalene-sulphonates.

Suitable dispersants and/or emulsifiers that may be present in the seed dressing formulations of the invention include all nonionic, anionic, and cationic dispersants which are customary in the formulation of active agrochemical substances as outlined above.

Suitable defoamers that may be present in the seed dressing formulations of the invention include all foam-inhibiting substances which are customary in the formulation of active agrochemical substances. With preference it is possible to use silicone defoamers and magnesium stearate.

Suitable preservatives that may be present in the seed dressing formulations of the invention include all substances which can be used for such purposes in agrochemical compositions. By way of example, mention may be made of dichlorophen and benzyl alcohol hemiformal.

Suitable secondary thickeners that may be present in the seed dressing formulations of the invention include all substances which can be used for such purposes in agrochemical compositions. Preferred suitability is possessed by cellulose derivatives, acrylic acid derivatives, xanthan, modified clays, and highly disperse silica.

Suitable adhesives that may be present in the seed dressing formulations of the invention include all customary binders which can be used in seed dressing. With preference, mention may be made of polyvinylpyrrolidone, polyvinyl acetate, polyvinyl alcohol and tylose.

Suitable gibberellins that may be present in the seed dressing formulations of the invention include preferably gibberelin A1, A3 (=gibberellinic acid), A4, and A7, particular preferably gibberelin A3 (=gibberellinic acid). The gibberellins of the formula (II) are known, the nomenclature of the gibberlins can be found the reference mentioned below (cf. R. Wegler “Chemie der Pflanzen-schutz- and Schädlingsbekampfungsmittel”, Volume 2, Springer Verlag, Berlin-Heidelberg-New York, 1970, pages 401-412).

Suitable mixing equipment for treating seed with the seed dressing formulations to be used according to the invention or the preparations prepared from them by adding water includes all mixing equipment which can commonly be used for dressing. The specific procedure adopted when dressing comprises introducing the seed into a mixer, adding the particular desired amount of seed dressing formulation, either as it is or following dilution with water beforehand, and carrying out mixing until the formulation is uniformly distributed on the seed. Optionally, a drying operation follows.

The invention is illustrated by the example below. The invention is not restricted to the example only.

1. A method of reducing afla- or ochratoxin contamination of cereal, nut, fruit, and spice plants, and/or plant material from cereals, nuts, fruits and spices before or after harvest or during storage, which comprises contacting a cereal, nut, fruit, or spice plant, or the plant material from cereals, nuts, fruits, or spices, before or after harvest, during storage with one fungicide or a combination of two or more fungicides selected from the group consisting of:
(Ia) a member of the azole group selected from the group consisting of Cyproconazole, Epoxiconazole, Flusilazole, Ipconazole, Propiconzole, Prothioconazole, Metconazole, Tebuconazole, and Triadimenol,
(Ib) a member of the strobilurin group selected from group consisting of Azoxystrobin Fluoxastrobin, Kresoxim-methyl, Picoxystrobin, Pyraclostrobin, and Triloxystrobin, and
(Ic) fungicide selected from the group consisting of Boscalid, Chlorothalonil, Cyprodinil, Fludioxonil, Fluopyram, Myclobutonil, Prochloraz, Spiroxamine, N-(3′,4′-dichloro-5-fluro[1,1′-biphenyl]-2-yl)-3-(difluoromethyl)-1-methyl-1H-pyrazole-4-carboxamide, 5-Chlor-6-(,4,6-trifluorohenyl)-7-(4-methylpiperidin-1-yl)[1,2,4]triazolo[1,5-a]pyrimidin, 1-methyl-N-{2-[1 ethyl-1,1′-bi(cyclopropyl)-2-yl]phenyl}-3-(trifluoromethyl)-1N-pyrazole-4-carboxamide, N-{2-[1,1″-bi(cyclopropyl)-2-yl]phenyl}-1-methyl-3-(trifluoromethyl)-1H-pyrazole-4-carboxamide, 1-methyl-N-{2-[1′-methyl-1,1′-bi(cyclopropyl)-2-yl]phenyl}-3(difluoromethyl)-1H-pyrazole-4-carboxamide, and N-{2-[1,1′-bi(cyclopropyl)-2-yl]phenyl}-1-methyl-3-(difluoromethyl)-1H-pyrazole-4-carboxamide.

2. The method according to claim 1, wherein the cereal, nut, fruit or spice plant, and/or plant material from cereals, nuts, fruits, or spices is genetically modified.

3. The method according to claim 1, wherein the afla- and ochratoxin contamination is caused by infestation of plants and/or plant material with Aspergillus flavus, Aspergillus parasiticus and Aspergillus nomius, A. ochraceus, A. carbonarius or P. viridicatum, before or after harvest, or during storage.

4. The method according to claim 1, wherein the plant is selected from the group consisting of a peanut, cashew, cocoa, raisin, grape, soybean, manioc, and cotton plant.

5. The method according to claim 1, wherein the afla- and ochratoxin are selected from the group consisting of aflatoxin B1, B2, G1, and G2 or and ochratoxin A, B, and C.

6. The method according to claim 1, wherein the fungicide is selected from the group consisting of Epoxiconazole, Ipconazole, Prothioconazole, Tebuconazole, Trifloxystrobin, Cyprodinil, and Fludioxonil.

7. The method according to claim 1, wherein the fungicide combination is selected from the group consisting of tebuconazole and prothioconazole, tebuconazole and trifloxystrobin, and trifloxystrobin and prothioconazole.

8. The method according to claim 1, wherein the plant and/or plant material before or after harvest or during storage are further treated with one or more attractants, sterilizing agents, bactericides, nematicides, fungicides, growth-regulating substances, herbicides, safeners, fertilizers, inoculants, or other plant-growth influencing compounds, or semiochemicals.
